(19) United States
(12) Patent Application Publication
(10) Pub. No.: US 2024/0179755 A1
(43) Pub. Date: May 30, 2024

(54) RANDOM ACCESS PARTITIONS FOR DIFFERENT USE CASES

(71) Applicant: QUALCOMM Incorporated, San Diego, CA (US)

(72) Inventors: Linhai HE, San Diego, CA (US); Peng CHENG, Beijing (CN); Jianhua LIU, Beijing (CN); Ruiming ZHENG, Beijing (CN); Jing LEI, San Diego, CA (US)

(21) Appl. No.: 18/552,618

(22) PCT Filed: May 6, 2021
(86) PCT No.: PCT/CN2021/091876

§ 371 Date: Sep. 26, 2023

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may receive, from a base station, a message indicating a common pool of resources for a random access channel (RACH). The UE may initiate a random access by transmitting, to the base station, a first RACH preamble in a RACH occasion within a subset of the common pool of resources. The subset is selected based at least in part on a use case that triggered the random access. In some aspects, the UE may transmit an initial RACH preamble and/or a RACH pay load in order to activate the subset. As an alternative, the UE may transmit an initial RACH preamble and/or a RACH payload in order to receive an indication of the subset for the use case that triggered the random access. Numerous other aspects are described.

### FIELD OF THE DISCLOSURE

Aspects of the present disclosure generally relate to wireless communication and to techniques and apparatuses for configuring and using random access partitions for different use cases.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or forward link) refers to the communication link from the BS to the UE, and “uplink” (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory and one or more processors coupled to the memory, the one or more processors configured to receive, from a base station, a message indicating a common pool of resources for a random access channel (RACH); and initiate a random access by transmitting, to the base station, a first RACH preamble in a RACH occasion within a subset of the common pool of resources, wherein the subset is selected based at least in part on a use case that triggered the random access.

In some aspects, a base station for wireless communication includes a memory and one or more processors coupled to the memory, the one or more processors configured to transmit, to a UE, a message indicating a common pool of resources for a RACH; and receive, from the UE, a first RACH preamble, to initiate a random access, in a RACH occasion within a subset of the common pool of resources, wherein the subset is selected based at least in part on a use case that triggered the random access.

In some aspects, a method of wireless communication performed by a UE includes receiving, from a base station, a message indicating a common pool of resources for a RACH; and initiating a random access by transmitting, to the base station, a first RACH preamble in a RACH occasion within a subset of the common pool of resources, wherein the subset is selected based at least in part on a use case that triggered the random access.

In some aspects, a method of wireless communication performed by a base station includes transmitting, to a UE, a message indicating a common pool of resources for a RACH; and receiving, from the UE, a first RACH preamble, to initiate a random access, in a RACH occasion within a subset of the common pool of resources, wherein the subset is selected based at least in part on a use case that triggered the random access.

In some aspects, a non-transitory computer-readable medium storing a set of instructions for wireless communication includes one or more instructions that, when executed by one or more processors of a UE, cause the UE to receive, from a base station, a message indicating a common pool of resources for a RACH; and initiate a random access by transmitting, to the base station, a first RACH preamble in a RACH occasion within a subset of the common pool of resources, wherein the subset is selected based at least in part on a use case that triggered the random access.

In some aspects, a non-transitory computer-readable medium storing a set of instructions for wireless communication includes one or more instructions that, when executed by one or more processors of a base station, cause the base station to transmit, to a UE, a message indicating a common pool of resources for a RACH; and receive, from the UE, a first RACH preamble, to initiate a random access, in a RACH occasion within a subset of the common pool of resources, wherein the subset is selected based at least in part on a use case that triggered the random access.

In some aspects, an apparatus for wireless communication includes means for receiving, from a base station, a message indicating a common pool of resources for a RACH; and means for initiating a random access by transmitting, to the base station, a first RACH preamble in a RACH occasion within a subset of the common pool of resources, wherein the subset is selected based at least in part on a use case that triggered the random access.

In some aspects, an apparatus for wireless communication includes means for transmitting, to a UE, a message indicating a common pool of resources for a RACH; and means for receiving, from the UE, a first RACH preamble, to initiate a random access, in a RACH occasion within a subset of the common pool of resources, wherein the subset is selected based at least in part on a use case that triggered the random access.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processors, interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of a four-step random access procedure, in accordance with the present disclosure.

FIG. 4 is a diagram illustrating an example of a two-step random access procedure, in accordance with the present disclosure.

FIG. 5 is a diagram illustrating an example associated with a common pool of resources for random access, in accordance with the present disclosure.

FIGS. 6 and 7 are diagrams illustrating examples associated with partitioning a common pool of resources for random access, in accordance with the present disclosure.

FIGS. 8, 9, and 10 are diagrams illustrating examples associated with requesting to use partitions of a common pool of resources for random access, in accordance with the present disclosure.

FIGS. 11 and 12 are diagrams illustrating example processes associated with configuring and using random access partitions for different use cases, in accordance with the present disclosure.

FIGS. 13 and 14 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

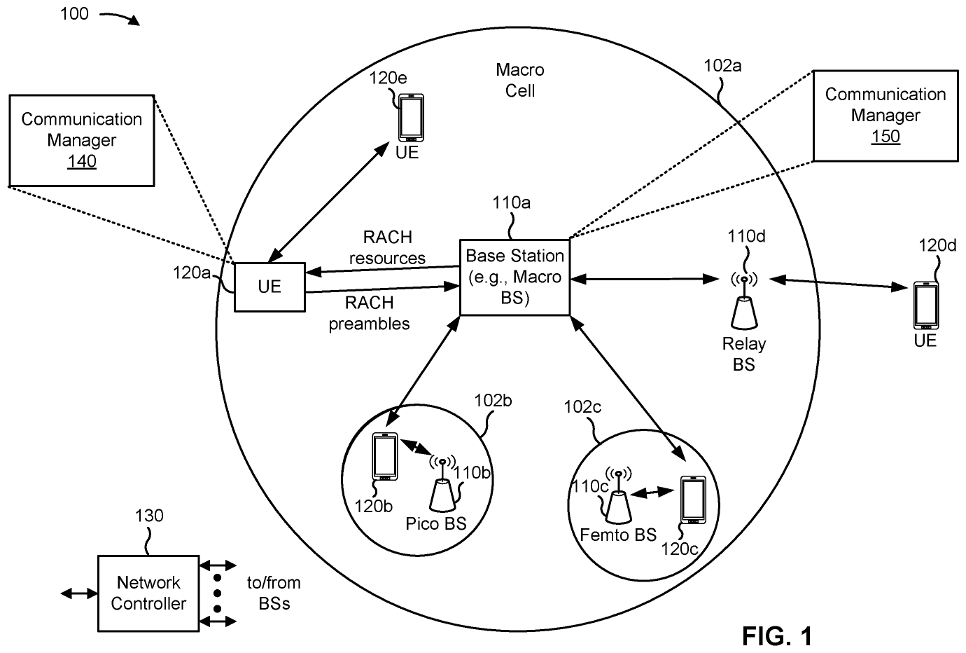

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, and/or may be implemented as NB-IOT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHZ, and/or may communicate using an operating band having a second frequency range (FR2), which may span from 24.25 GHz to 52.6 GHz. The frequencies between FRI and FR2 are sometimes referred to as mid-band frequencies. Although a portion of FRI is greater than 6 GHZ, FRI is often referred to as a “sub-6 GHz” band. Similarly, FR2 is often referred to as a “millimeter wave” band despite being different from the extremely high frequency (EHF) band (30 GHZ-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, and as shown in FIG. 1, the UE 120 may include a communication manager 140. As further shown in FIG. 1, and as described in more detail elsewhere herein, the communication manager 140 may receive (e.g., from the base station 110) a message indicating a common pool of resources for a random access channel (RACH), and may initiate a random access by transmitting (e.g., to the base station 110) a first RACH preamble in a RACH occasion within a subset of the common pool of resources, where the subset is selected based at least in part on a use case that triggered the random access. Additionally, or alternatively, the communication manager 140 may perform one or more other operations described herein.

Similarly, in some aspects, the base station 110 may include a communication manager 150. As shown in FIG. 1, and as described in more detail elsewhere herein, the communication manager 150 may transmit (e.g., to the UE 120) a message indicating a common pool of resources for a RACH, and may receive (e.g., from the UE 120) a first RACH preamble, to initiate a random access, in a RACH occasion within a subset of the common pool of resources, where the subset is selected based at least in part on a use case that triggered the random access. Additionally, or alternatively, the communication manager 150 may perform one or more other operations described herein.

As indicated above, FIG. 1 is provided as an example. Other examples may differ from what is described with regard to FIG. 1.

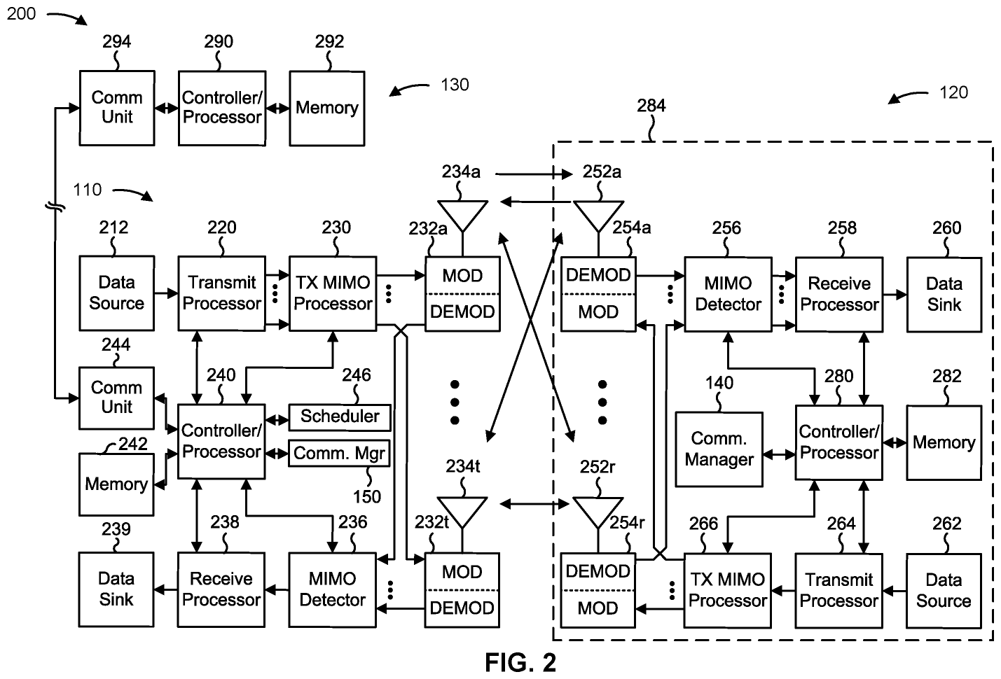

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

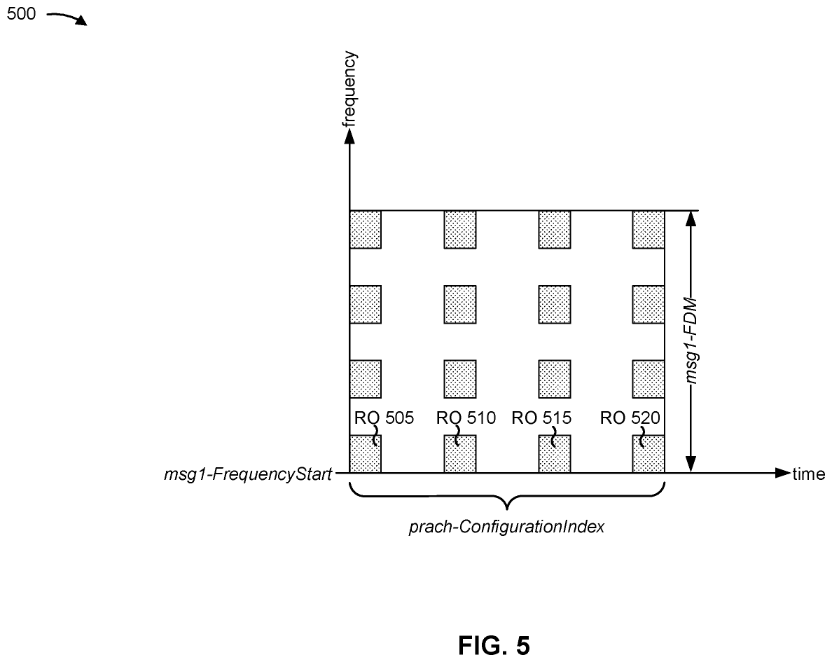

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, with reference to FIGS. 5-12).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, with reference to FIGS. 5-12).

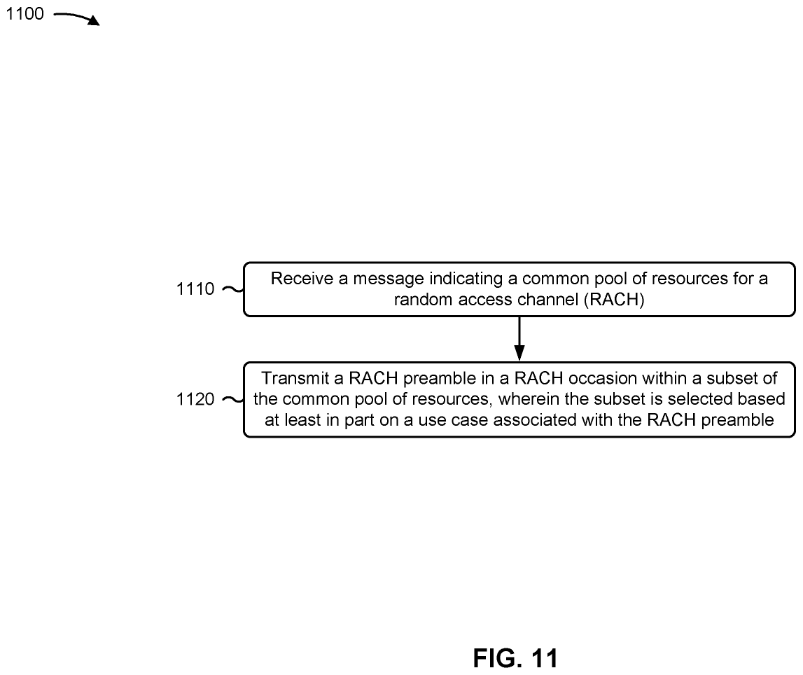

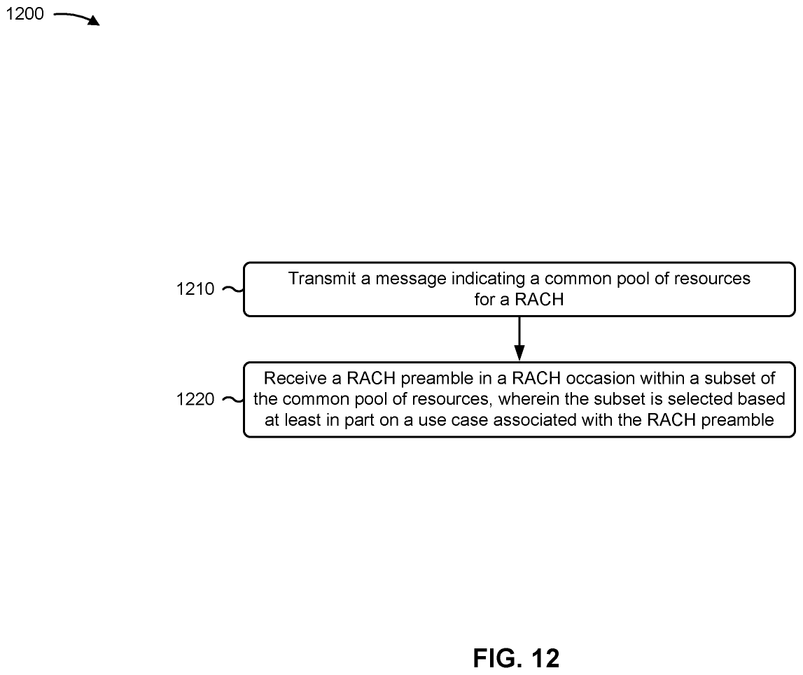

Controller/processor 240 of base station 110, controller/processor 280 of UE 120, and/or any other component(s) of FIG. 2 may perform one or more techniques associated with configuring and using random access partitions for different use cases, as described in more detail elsewhere herein. For example, controller/processor 240 of base station 110, controller/processor 280 of UE 120, and/or any other component(s) of FIG. 2 may perform or direct operations of, for example, process 1100 of FIG. 11, process 1200 of FIG. 12, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, process 1200 of FIG. 12, and/or other processes as described herein. In some aspects, executing instructions may include running the instructions, converting the instructions, compiling the instructions, and/or interpreting the instructions, among other examples.

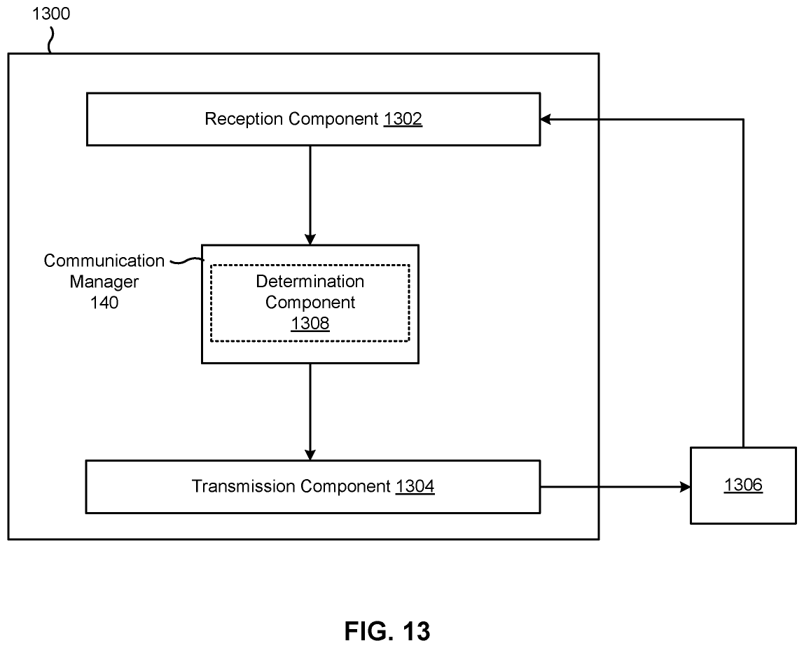

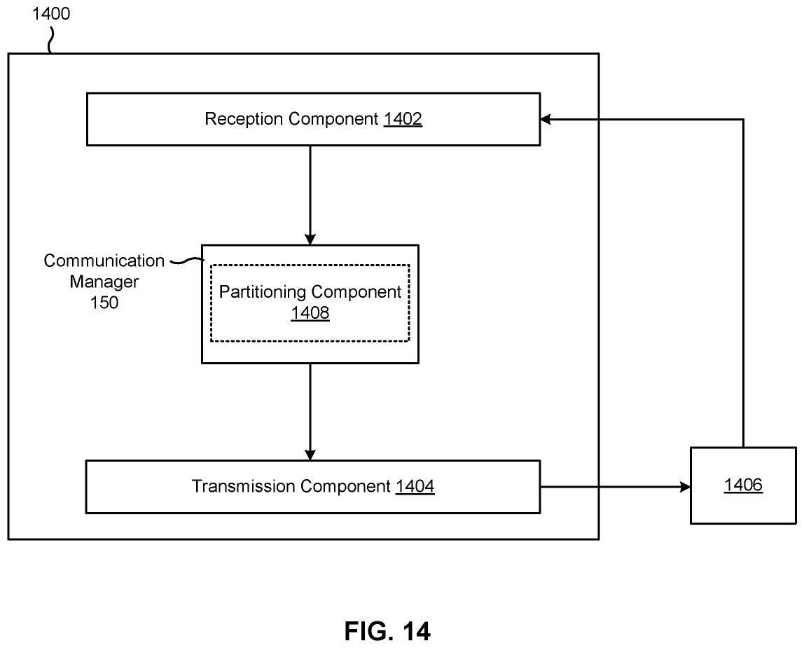

In some aspects, a UE (e.g., the UE 120 and/or apparatus 1300 of FIG. 13) may include means for receiving, from a base station (e.g., the base station 110 and/or apparatus 1400 of FIG. 14), a message indicating a common pool of resources for a RACH; and/or means for initiating a random access by transmitting, to the base station, a first RACH preamble in a RACH occasion within a subset of the common pool of resources, wherein the subset is selected based at least in part on a use case that triggered the random access. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a base station (e.g., the base station 110 and/or apparatus 1400 of FIG. 14) may include means for transmitting, to a UE (e.g., the UE 120 and/or apparatus 1300 of FIG. 13)), a message indicating a common pool of resources for a RACH; and/or means for receiving, from the UE, a first RACH preamble, to initiate a random access, in a RACH occasion within a subset of the common pool of resources, wherein the subset is selected based at least in part on a use case that triggered the random access. The means for the base station to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

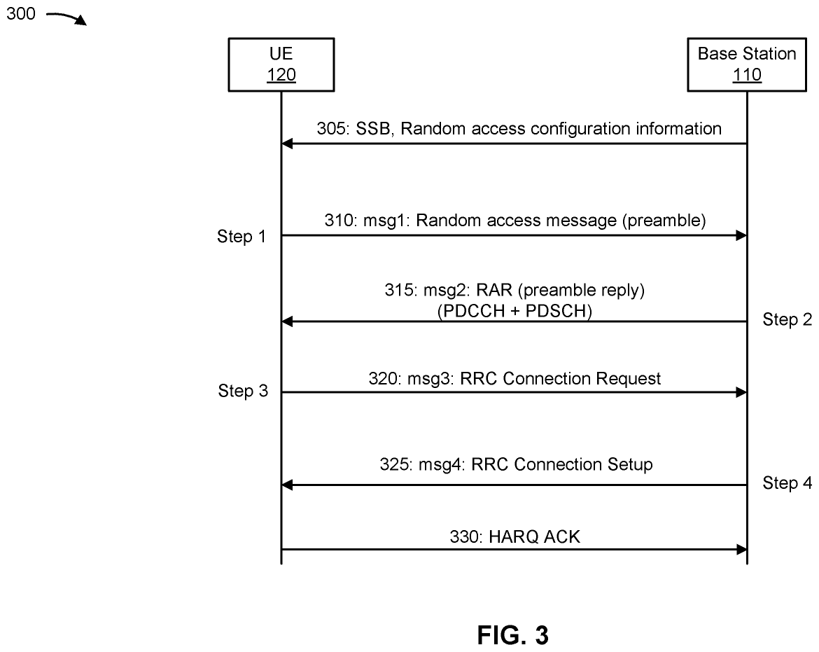

FIG. 3 is a diagram illustrating an example of a four-step random access procedure, in accordance with the present disclosure. As shown in FIG. 3, a base station 110 and a UE 120 may communicate with one another to perform the four-step random access procedure.

As shown by reference number 305, the base station 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

In some aspects, the random access configuration information may include a plurality of configurations, where each configuration corresponds to one or more use cases for the UE 120. For example, the base station 110 may provide one random access configuration for small data transfers to and/or from the UE 120, another random access configuration for ultra-reliable low-latency communications (URLLCs), and other random access configurations for network slices. As used herein, “network slicing” may refer to a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing can efficiently provide communications for different types of services with different service standards. Accordingly, by providing network slicing, a core network supporting the base station 110 may deploy multiple substantially independent end-to-end networks potentially with the same infrastructure using different slices that are customized for different services.

As shown by reference number 310, the UE 120 may transmit a RAM, which may include a preamble (sometimes referred to as a random access preamble, a physical RACH (PRACH) preamble, or a RAM preamble). The message that includes the preamble may be referred to as a message 1, msg1, MSG1, a first message, or an initial message in a four-step random access procedure. The random access message may include a random access preamble identifier.

As shown by reference number 315, the base station 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the base station 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the base station 110 may transmit the PDSCH communication for the RAR, as scheduled by the PDCCH communication. The RAR may be included in a medium access control (MAC) protocol data unit (PDU) of the PDSCH communication.

As shown by reference number 320, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 325, the base station 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 330, if the UE 120 successfully receives the RRC connection setup message, the UE 120 may transmit a hybrid automatic repeat request (HARQ) acknowledgement (ACK).

As indicated above, FIG. 3 is provided as an example. Other examples may differ from what is described with regard to FIG. 3.

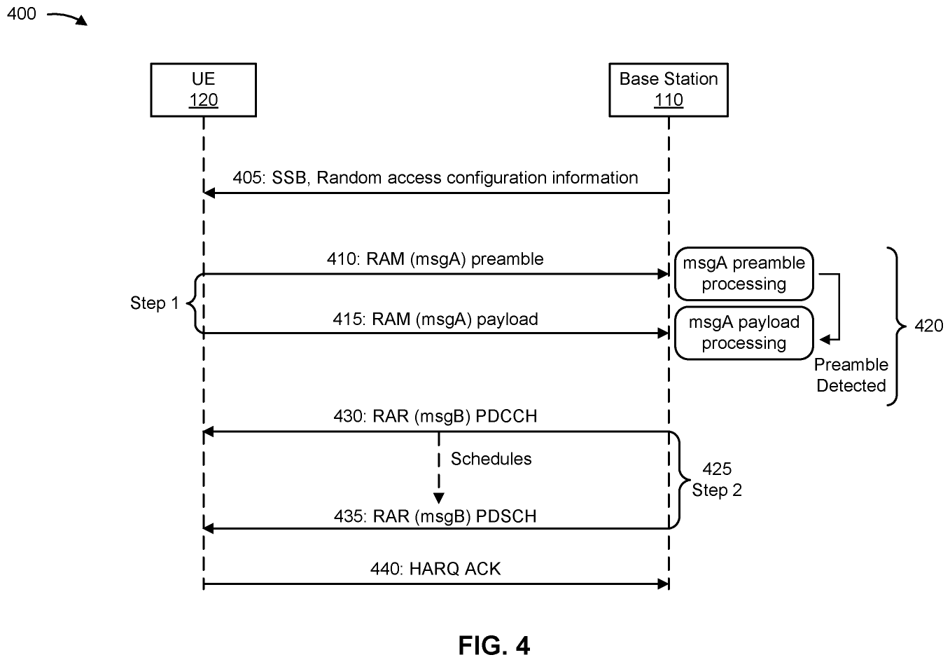

FIG. 4 is a diagram illustrating an example 400 of a two-step random access procedure, in accordance with the present disclosure. As shown in FIG. 4, a base station 110 and a UE 120 may communicate with one another to perform the two-step random access procedure.

As shown by reference number 405, the base station 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a RAM and/or receiving an RAR to the RAM.

In some aspects, the random access configuration information may include a plurality of configurations, where each configuration corresponds to one or more use cases for the UE 120. For example, the base station 110 may provide one random access configuration for small data transfers to and/or from the UE 120, another random access configuration for URLLCs, and other random access configurations for network slices.

As shown by reference number 410, the UE 120 may transmit, and the base station 110 may receive, a RAM preamble. As shown by reference number 415, the UE 120 may transmit, and the base station 110 may receive, a RAM payload. As shown, the UE 120 may transmit the RAM preamble and the RAM payload to the base station 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a physical random access channel (PRACH) preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 420, the base station 110 may receive the RAM preamble transmitted by the UE 120. If the base station 110 successfully receives and decodes the RAM preamble, the base station 110 may then receive and decode the RAM payload. If the base station 110 successfully receives and decodes the RAM preamble but fails to receive and/or successfully decode the RAM payload, the base station 110 may fall back to a two-step random access procedure (e.g., as described above in connection with FIG. 3). For example, the base station 10 may transmit a msg2 as described above in connection with FIG. 3 in lieu of msgB as described below in connection with reference number 425.

As shown by reference number 425, the base station 110 may transmit an RAR (sometimes referred to as an RAR message). As shown, the base station 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 430, as part of the second step of the two-step random access procedure, the base station 110 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 435, as part of the second step of the two-step random access procedure, the base station 110 may transmit the PDSCH communication for the RAR, as scheduled by the PDCCH communication. The RAR may be included in a MAC PDU of the PDSCH communication. As shown by reference number 440, if the UE 120 successfully receives the RAR, the UE 120 may transmit a HARQ ACK.

As indicated above, FIG. 4 is provided as an example. Other examples may differ from what is described with regard to FIG. 4.

As described above in connection with FIGS. 3-4, a base station may provide different random access configurations for different use cases. For example, the base station may provide different random access configurations so that the base station can more quickly determine which use case is associated with a random access preamble from a UE and configure a RACH that is appropriate to the use case. Additionally, or alternatively, the base station may provide different preamble-transmission parameters for different use cases. For example, the base station may configure a larger transmit power for random access preambles associated with URLLCs so that the base station is more likely to receive and successfully decode the preamble, but may configure a smaller transmit power for random access preambles associated with lower priority network slices to conserve battery power of the UE.

Providing different random access configurations generally results in high signaling overhead. For example, the base station may transmit a separate RACH-Config data structure (e.g., as defined in 3GPP specifications and/or another standard) for each random access configuration. However, many parameters, such as preamble ReceivedTargetPower, preamble TransMax, power RampingStep, and/or other preamble-transmission parameters, may be the same across different random access configurations, which results in wasted processing resources, network resources, and power at the base station and at the UE. Moreover, because the random access configurations are generally provided via SIBs, providing more random access configurations increases the chances that the UE will fail to receive and/or successfully decode the SIBs from the base station as the SIBs increase in size. The UE will not be able to enter an RRC connected state with the base station when the SIBs are not received and/or successfully decoded, which thus wastes processing resources and power at the UE as well as increasing latency before the UE can communicate with the base station.

Some techniques and apparatuses described herein enable a base station (e.g., base station 110) to partition PRACH resources according to different use cases. As a result, the base station 110 may provide a common pool of PRACH resources along with partition information for one or more use cases. Signaling overhead is lower for the common pool and the partition information as compared with signaling a plurality of random access configurations. As a result, the base station 110 conserves processing resources, network resources, and power at both the base station 110 and at a UE (e.g., UE 120) using the PRACH resources. The base station 110 also reduces a size of the SIBs as compared with providing a plurality of random access configurations in the SIBs. As a result, the base station 110 increases the chances that the UE 120 will receive and successfully decode the SIBs from the base station 110. On average, this allows the UE 120 to enter an RRC connected state with the base station 110 sooner, which conserves processing resources and power at the UE 120 as well as decreasing latency before the UE 120 can communicate with the base station. Additionally, in some aspects, the base station 110 may provide the partitions to the UE 120 by request. Accordingly, the base station 110 may more efficiently allocate PRACH resources between the partitions because the base station 110 does not have to reserve network resources for partitions that are not in use. Accordingly, spectrum and other network resources are more efficiently utilized.

FIG. 5 is a diagram illustrating an example 500 associated with a common pool of resources for random access, in accordance with the present disclosure. As shown in FIG. 5, the common pool includes a plurality of random access occasions (ROs), such as RO 505, RO 510, RO 515, and RO 520, in which a UE (e.g., UE 120) may initiate a random access (e.g., by transmitting a RACH preamble as described above in connection with FIG. 3 or FIG. 4).

A base station (e.g., base station 110) may configure the common pool by transmitting a message to one or more UEs (e.g., including the UE 120) that indicates the common pool. For example, the message may be a broadcast message, such as an SIB. Additionally, or alternatively, the message may be an RRC message, a MAC control element (MAC-CE), DCI, and/or another similar downlink message.

As shown in FIG. 5, each RO may include a portion of a frequency domain and a portion of a time domain. Accordingly, the base station 110 may include, in the message configuring the common pool, a starting frequency (e.g., indicated by a msg1-FrequencyStart data element, as defined in 3GPP specifications and/or another standard), a quantity of ROs within a slot (e.g., indicated by a msg1-FDM data element, as defined in 3GPP specifications and/or another standard), and/or a time domain pattern indicator (e.g., a prach-ConfigurationIndex, as defined in 3GPP specifications and/or another standard). As used herein, “slot” may refer to a portion of a subframe, which in turn may be a fraction of a radio frame within an LTE, 5G, or other wireless communication structure. In some aspects, a slot may include one or more symbols. Additionally, “symbol” may refer to an OFDM symbol or another similar symbol within a slot. Although example 500 encompasses four slots, the common pool may be periodic (e.g., repeating according to an amount of time, a quantity of symbols, a quantity of slots, a quantity of subframes, and/or a quantity of frames).

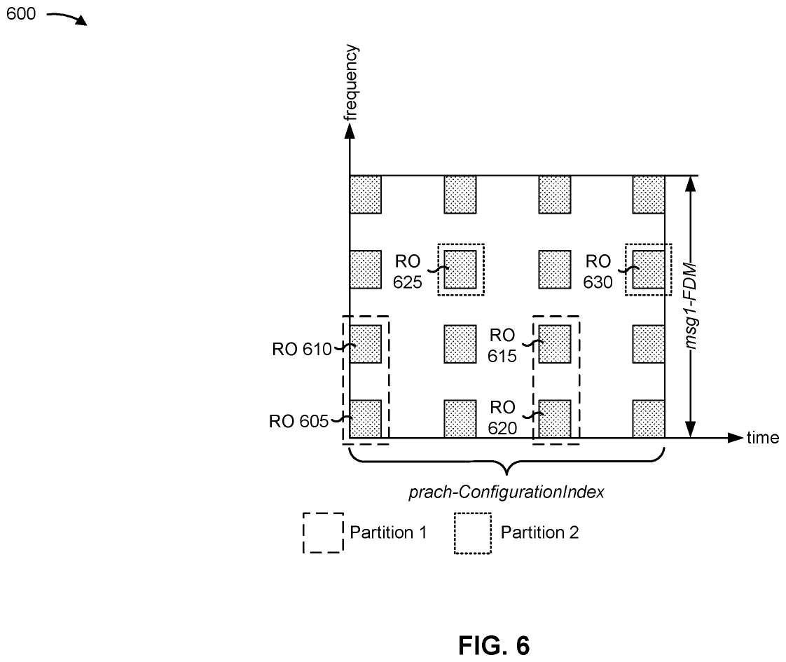

Accordingly, the UE 120 may initiate a random access using resources associated with the ROs in the common pool. In some aspects, the base station 110 may additionally indicate at least one preamble-transmission parameter in the message configuring the common pool. For example, the base station 110 may indicate a total quantity of RACH preambles that can be transmitted in the common pool (e.g., indicated by a totalNumberOfRA-Preambles data element, as defined in 3GPP specifications and/or another standard), a target received power associated with RACH preambles transmitted in the common pool (e.g., indicated by a preamble ReceivedTargetPower data element, as defined in 3GPP specifications and/or another standard), a maximum transmit power associated with RACH preambles transmitted in the common pool, a power ramping step associated with RACH preambles transmitted in the common pool (e.g., indicated by a powerRampingStep data element, as defined in 3GPP specifications and/or another standard), and/or a response window associated with RACH preambles transmitted in the common pool (e.g., indicated by a ra-ResponseWindow data element, as defined in 3GPP specifications and/or another standard). Accordingly, the UE 120 may use the preamble-transmission parameter(s) when initiating a random access using the ROs in the common pool (unless a partition within the common pool has a different corresponding preamble-transmission parameter, as described below in connection with FIGS. 6-10).

By using a common pool as described in connection with FIG. 5, the base station 110 may partition the common pool according to different use cases (e.g., as described below in connection with FIGS. 6-10). As a result, the base station 110 may reduce a size of the SIBs (or other messages) configuring the common pool and the partitions as compared with signaling a plurality of random access configurations for the different use cases. This conserves processing resources, network resource, and power at the base station 110 and the UE 120.

As indicated above, FIG. 5 is provided as an example. Other examples may differ from what is described with respect to FIG. 5.

FIG. 6 is a diagram illustrating an example 600 associated with partitioning a common pool of resources for random access, in accordance with the present disclosure. Similar to example 500, example 600 includes a common pool with a plurality of ROs, such as RO 605, RO 610, RO 615, RO 620, RO 625, and RO 630 in which a UE (e.g., UE 120) may initiate a random access (e.g., by transmitting a RACH preamble as described above in connection with FIG. 3 or FIG. 4).

A base station (e.g., base station 110) may configure the common pool by transmitting a message to one or more UEs (e.g., including the UE 120) that indicates the common pool. For example, the message may be a broadcast message, such as an SIB. Additionally, or alternatively, the message may be an RRC message, a MAC-CE, DCI, and/or another similar downlink message.

As described above in connection with FIG. 5, each RO may include a portion of a frequency domain and a portion of a time domain. Accordingly, the base station 110 may include, in the message configuring the common pool, a starting frequency (e.g., indicated by a msg 1-FrequencyStart data element, as defined in 3GPP specifications and/or another standard), a quantity of ROs within a slot (e.g., indicated by a msg1-FDM data element, as defined in 3GPP specifications and/or another standard), and/or a time domain pattern indicator (e.g., a prach-ConfigurationIndex, as defined in 3GPP specifications and/or another standard).

The base station 110 may further configure one or more partitions within the common pool (e.g., shown as “Partition 1” and “Partition 2” in FIG. 6). For example, the base station 110 may indicate, for each partition, a starting frequency for the partition (e.g., indicated by a msg1-FrequencyStart data element, as defined in 3GPP specifications and/or another standard). The base station 110 may further indicate a quantity of ROs within a slot included in the partition (e.g., indicated by a msg1-FDM data element, as defined in 3GPP specifications and/or another standard) and/or may use a mask (e.g., a bitmap) indicating a subset of ROs within the slot that are included in the partition. For example, the bitmap may be set to (1, 1, 0, 0) for Partition 1 in example 600 such that the first two ROs in ascending order along the frequency domain are included in Partition 1. Similarly, the base station 110 may use a time domain pattern indicator (e.g., a prach-ConfigurationIndex, as defined in 3GPP specifications and/or another standard) to indicate a pattern of ROs along the time domain included in the partition and/or may use a mask (e.g., a bitmap) indicating a subset of ROs along the time domain that are included in the partition. For example, the bitmap may be set to (0, 1, 0, 1) for Partition 2 in example 600 such that the second and fourth ROs in ascending order along the time domain are included in Partition 2. Although example 600 encompasses four slots, the common pool and corresponding partitions may be periodic (e.g., repeating according to an amount of time, a quantity of symbols, a quantity of slots, a quantity of subframes, and/or a quantity of frames).

The base station 110 may associate each partition with at least one use case. In some aspects, one or more partitions may support multiple use cases (e.g., multiple network slices). The base station 110 may further indicate, for each partition, a mapping between SSBs transmitted by the base station 110 and the ROs included in the partition. For example, the base station 110 may use an ssb-per RACH-Occasion AndCB-PreamblesPerSSB data structure (e.g., as defined in 3GPP specifications and/or another standard) to indicate the mapping for the partition.

Accordingly, the UE 120 may initiate a random access based at least in part on a use case associated with the random access. For example, the UE 120 may determine which use case (e.g., a small data transfer, a network slice, a URLLC, and/or another use case) triggered the random access. Accordingly, when the use case is associated with a partition (e.g., Partition 1 or Partition 2 in example 600), the UE 120 may initiate the random access using an RO included in the partition (e.g., by transmitting a RACH preamble within the RO). When the use case is not associated with a partition, the UE 120 may initiate the random access using an RO not included in any partition (e.g., by transmitting a RACH preamble within one of the ROs that is not RO 605, RO 610, RO 615, RO 620, RO 625, or RO 630).

In some aspects, the base station 110 may additionally indicate, for a partition, at least one preamble-transmission parameter. For example, the base station 110 may indicate a total quantity of RACH preambles that can be transmitted in the partition (e.g., indicated by a totalNumberOfRA-Preambles data element, as defined in 3GPP specifications and/or another standard), a target received power associated with RACH preambles transmitted in the partition (e.g., indicated by a preambleReceivedTargetPower data element, as defined in 3GPP specifications and/or another standard), a maximum transmit power associated with RACH preambles transmitted in the partition, a power ramping step associated with RACH preambles transmitted in the partition (e.g., indicated by a powerRampingStep data element, as defined in 3GPP specifications and/or another standard), and/or a response window associated with RACH preambles transmitted in the partition (e.g., indicated by a ra-Response Window data element, as defined in 3GPP specifications and/or another standard). Accordingly, the UE 120 may use any preamble-transmission parameters, indicated for the partition, when initiating a random access within the partition. The UE 120, however, may use a preamble-transmission parameter indicated for the common pool whenever a corresponding preamble-transmission parameter is not specified for the partition. As a result, the base station 110 may eliminate redundancy that occurs when signaling a plurality of random access configurations for the different use cases, which reduces a size of the SIBs (or other messages) used to configure the common pool and the partitions.

By using partitions as described in connection with FIG. 6, the base station 110 may optimize different portions of the common pool for different use cases. For example, the base station 110 may provide more ROs for high-time-sensitive use cases (such as some network slices and/or URLLCs) to decrease latency for those use cases, while providing fewer ROs for low-time-sensitive use cases (such as small data transfer and/or other network slices) to conserve power at the UE 120 and the base station 110. Additionally, in some aspects, the base station 110 may provide a higher transmit power, a longer response window, and/or another different preamble-transmission parameter associated with higher-priority use cases (such as some network slices and/or URLLCs) to increase chances of success of the random access for those use cases, while providing a lower transmit power, a shorter response window, and/or another different preamble-transmission parameter associated with lower-priority use cases (such as small data transfer and/or other network slices) to conserve power at the UE 120 and the base station 110.

Additionally, as described above, the base station 110 may reduce a size of the SIBs (or other messages) configuring the common pool and the partitions. Using smaller SIBs (or other messages) conserves processing resources, network resource, and power at the base station 110 and the UE 120. Using smaller SIBs (or other messages) additionally increases the chances that the UE 120 will receive and successfully decode the SIBs from the base station 110, which decreases latency before the UE 120 can communicate with the base station 110.

As indicated above, FIG. 6 is provided as an example. Other examples may differ from what is described with respect to FIG. 6.

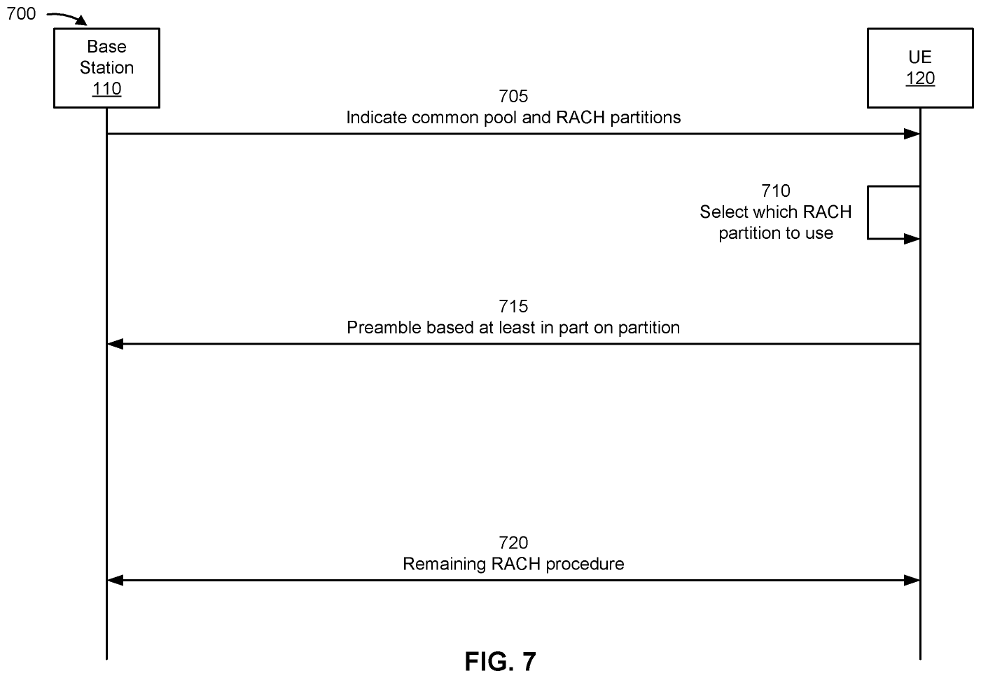

FIG. 7 is a diagram illustrating an example 700 associated with partitioning a common pool of resources for random access, in accordance with the present disclosure. As shown in FIG. 7, a base station 110 and a UE 120 may communicate with one another.

As shown in connection with reference number 705, the base station 110 may transmit, and the UE 120 may receive, a message indicating a common pool of resources for a RACH and an indication of a plurality of subsets (also referred to as “partitions”) within the common pool of resources. For example, the message and/or the indication may be included in one or more SIBs and/or other broadcast messages. Additionally, or alternatively, the message and/or the indication may be included in one or more RRC messages, one or more MAC-CEs, DCI, and/or other downlink messages. In some aspects, the message may indicate a starting frequency, a quantity of RACH occasions per slot, a time domain pattern indicator, and/or at least one preamble-transmission parameter (e.g., as described above in connection with FIG. 5).

In some aspects, the indication may include, for each subset, a corresponding mapping between an SSB and one or more corresponding ROs of the subset (e.g., as described above in connection with FIG. 6). Additionally, in some aspects, the indication may include, for at least one of the subsets, at least one preamble-transmission parameter (e.g., as described above in connection with FIG. 6).

The base station 110 may further indicate at least one use case associated with each subset. Accordingly, as shown in connection with reference number 710, when a random access is triggered at the UE 120, the UE 120 may determine which subset to use based at least in part on the use case that triggered the random access (e.g., as described above in connection with FIG. 6). In some aspects, the selected subset may include a portion of the common pool of resources that is not associated with a use case (e.g., when the use case that triggered the random access is not associated with a partition, as described above in connection with FIG. 6).

As further shown in FIG. 7 and in connection with reference number 715, the UE 120 may transmit, and the base station 110 may receive, a first RACH preamble in an RO within the selected subset. Accordingly, the base station 110 may infer which use case triggered the random access based at least in part on the RO in which the UE 120 transmitted the first RACH preamble.

In some aspects, the UE 120 may use any preamble-transmission parameters, indicated for the selected subset, when transmitting the first RACH preamble. Accordingly, the base station 110 may additionally or alternatively infer which use case triggered the random access based at least in part on the preamble-transmission parameter(s) used by the UE 120. When a preamble-transmission parameter is not specified for the selected subset, the UE 120 may use a corresponding preamble-transmission parameter indicated for the common pool (e.g., as described above in connection with FIG. 6).

As shown in connection with reference number 720, the UE 120 and the base station 110 may complete the random access initiated by the first RACH preamble. For example, the UE 120 and the base station 110 may perform additional operations associated with a four-step random access procedure (e.g., as described above in connection with FIG. 3) and/or with a two-step random access procedure (e.g., as described above in connection with FIG. 4).

By using techniques as described in connection with FIG. 7, the base station 110 may optimize different portions of the common pool for different use cases. For example, the base station 110 may provide more ROs for high-time-sensitive use cases (such as some network slices and/or URLLCs) to decrease latency for those use cases, while providing fewer ROs for low-time-sensitive use cases (such as small data transfer and/or other network slices) to conserve power at the UE 120 and the base station 110. Additionally, in some aspects, the base station 110 may provide a higher transmit power, a longer response window, and/or another different preamble-transmission parameter associated with higher-priority use cases (such as some network slices and/or URLLCs) to increase chances of success of the random access for those use cases, while providing a lower transmit power, a shorter response window, and/or another different preamble-transmission parameter associated with lower-priority use cases (such as small data transfer and/or other network slices) to conserve power at the UE 120 and the base station 110.

As indicated above, FIG. 7 is provided as an example. Other examples may differ from what is described with respect to FIG. 7.

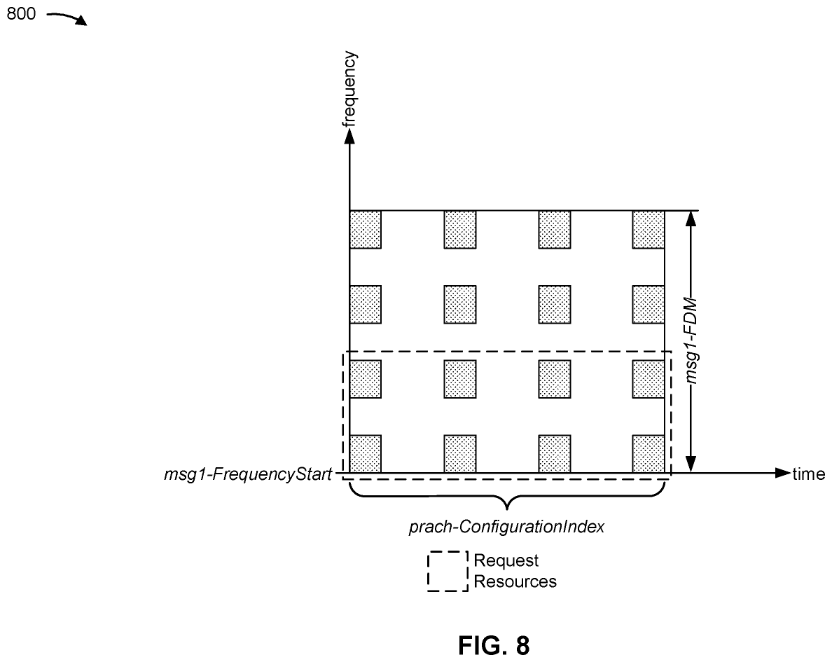

FIG. 8 is a diagram illustrating an example 800 associated with requesting to use partitions of a common pool of resources for random access, in accordance with the present disclosure. Similar to example 500, example 800 includes a common pool with a plurality of ROs in which a UE (e.g., UE 120) may initiate a random access (e.g., by transmitting a RACH preamble as described above in connection with FIG. 3 or FIG. 4).

A base station (e.g., base station 110) may configure the common pool by transmitting a message to one or more UEs (e.g., including the UE 120) that indicates the common pool. For example, the message may be a broadcast message, such as an SIB. Additionally, or alternatively, the message may be an RRC message, a MAC-CE, DCI, and/or another similar downlink message.

As described above in connection with FIG. 5, each RO may include a portion of a frequency domain and a portion of a time domain. Accordingly, the base station 110 may include, in the message configuring the common pool, a starting frequency (e.g., indicated by a msg 1-FrequencyStart data element, as defined in 3GPP specifications and/or another standard), a quantity of ROs within a slot (e.g., indicated by a msg1-FDM data element, as defined in 3GPP specifications and/or another standard), and/or a time domain pattern indicator (e.g., a prach-ConfigurationIndex, as defined in 3GPP specifications and/or another standard).

The base station 110 may further configure a subset, associated with requests for RACH partitions, within the common pool (e.g., shown as “Request Resources” in FIG. 8). For example, the base station 110 may indicate, for the subset, a starting frequency for the partition (e.g., indicated by a msg1-FrequencyStart data element, as defined in 3GPP specifications and/or another standard). The base station 110 may further indicate a quantity of ROs within a slot included in the subset (e.g., indicated by a msg1-FDM data element, as defined in 3GPP specifications and/or another standard) and/or may use a mask (e.g., a bitmap) indicating a portion of ROs within the slot that are included in the subset. For example, the bitmap may be set to (1, 1, 0, 0) for the request resources in example 800 such that the first two ROs in ascending order along the frequency domain are included in the request resources. Similarly, the base station 110 may use a time domain pattern indicator (e.g., a prach-ConfigurationIndex, as defined in 3GPP specifications and/or another standard) to indicate a pattern of ROs along the time domain included in the subset and/or may use a mask (e.g., a bitmap) indicating a portion of ROs along the time domain that are included in the subset. For example, the bitmap may be set to (1, 1, 1, 1) for the request resources in example 800 such that all four ROs along the time domain are included in the request resources. Although example 800 encompasses four slots, the common pool and corresponding subsets may be periodic (e.g., repeating according to an amount of time, a quantity of symbols, a quantity of slots, a quantity of subframes, and/or a quantity of frames).

The base station 110 may further indicate a mapping between SSBs transmitted by the base station 110 and the ROs included in the subset. For example, the base station 110 may use an ssb-perRACH-OccasionAndCB-PreamblesPerSSB data structure (e.g., as defined in 3GPP specifications and/or another standard) to indicate the mapping for the subset.

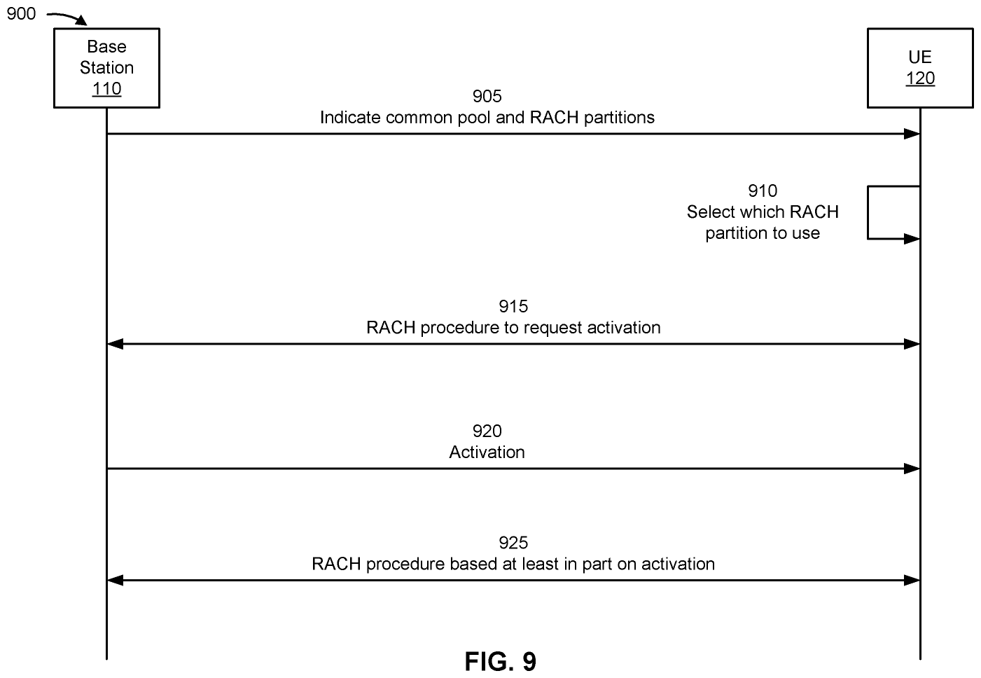

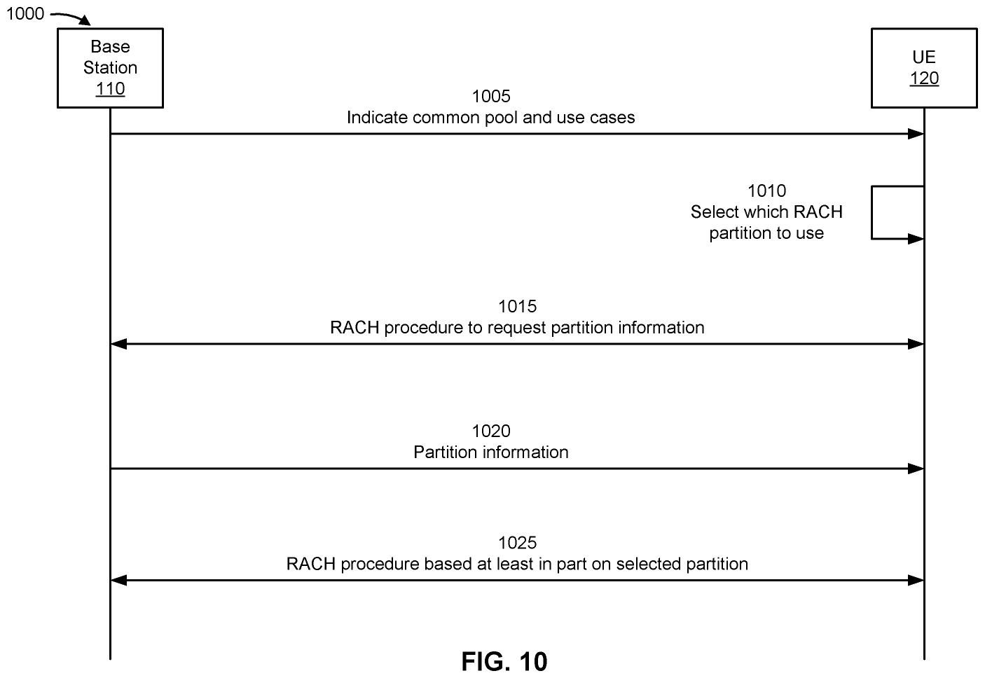

The base station 110 may associate one or more ROs of the subset, associated with requests for RACH partitions, with at least one use case. Accordingly, the UE 120 may use an RO, of the one or more ROs, to request activation of a partition associated with a use case, of the at least one use case (e.g., as described above in connection with FIG. 6). For example, the UE 120 may determine which use case (e.g., a small data transfer, a network slice, a URLLC, and/or another use case) triggered a random access and then transmit a RACH preamble in the one or more ROs associated with that use case in order to request activation of the partition associated with the use case. The base station 110 may activate the partition by inferring which use case triggered the random access based at least in part on the RO used by the UE 120. The UE 120 may then use the partition to perform the random access after activation (e.g., as described below in connection with FIG. 9 or FIG. 10).

Additionally, or alternatively, the base station 110 may associate one or more RACH preambles with at least one use case. Accordingly, the UE 120 may transmit a preamble, of the one or more RACH preambles, to request activation of a partition associated with a use case, of the at least one use case (e.g., as described above in connection with FIG. 6). For example, the UE 120 may determine which use case (e.g., a small data transfer, a network slice, a URLLC, and/or another use case) triggered a random access and then transmit a RACH preamble associated with that use case, in the subset of the common pool, in order to request activation of the partition associated with the use case. The base station 110 may activate the partition by inferring which use case triggered the random access based at least in part on the RACH preamble transmitted by the UE 120. The UE 120 may then use the partition to perform the random access after activation (e.g., as described below in connection with FIG. 9 or FIG. 10). In one combinatory example, the UE 120 may select a RACH preamble associated with the use case that triggered the random access and transmit the selected preamble in an RO, within the subset, associated with the use case. For example, the selected preamble may be associated with a plurality of use cases and/or the RO may be associated with a plurality of use cases such that the combination of the selected preamble with the RO indicates a single use case to the base station 110.

Additionally, or alternatively, the UE 120 may indicate which use case triggered the random access in a RAM payload (e.g., msg3 of a four-step random access procedure as described above in connection with FIG. 3, or msgA of a two-step random access procedure as described above in connection with FIG. 4). For example, the UE 120 may determine which use case (e.g., a small data transfer, a network slice, a URLLC, and/or another use case) triggered the random access and then transmit a RACH preamble in an RO of the subset. The UE 120 may request activation of the partition associated with the use case that triggered the random access using a random access payload rather than the RACH preamble and/or the RO. The base station 110 may activate the partition based at least in part on the payload transmitted by the UE 120. The UE 120 may then use the partition to perform the random access after activation (e.g., as described below in connection with FIG. 9 or FIG. 10).

In any of the aspects described above, the base station 110 may additionally indicate, for the subset, at least one preamble-transmission parameter. For example, the base station 110 may indicate a total quantity of RACH preambles that can be transmitted in the subset (e.g., indicated by a totalNumberOfRA-Preambles data element, as defined in 3GPP specifications and/or another standard), a target received power associated with RACH preambles transmitted in the subset (e.g., indicated by a preambleReceivedTargetPower data element, as defined in 3GPP specifications and/or another standard), a maximum transmit power associated with RACH preambles transmitted in the subset, a power ramping step associated with RACH preambles transmitted in the subset (e.g., indicated by a powerRampingStep data element, as defined in 3GPP specifications and/or another standard), and/or a response window associated with RACH preambles transmitted in the subset (e.g., indicated by a ra-Response Window data element, as defined in 3GPP specifications and/or another standard). Accordingly, the UE 120 may use any preamble-transmission parameters, indicated for the subset, when initiating a random access within the subset. The UE 120, however, may use a preamble-transmission parameter indicated for the common pool whenever a corresponding preamble-transmission parameter is not specified for the subset.

By using requests as described in connection with FIG. 8, the base station 110 may more efficiently allocate PRACH resources between the partitions because the UE 120 will not use a particular partition until the partition is activated. As a result, the base station 110 does not have to reserve network resources for partitions that are not in use, which allows the base station 110 to more efficiently allocate spectrum and other network resources according to demand.

Additionally, in some aspects, the base station 110 may not indicate which ROs are associated with which partitions until the UE 120 transmits a request. As a result, the base station 110 has even greater flexibility in allocating spectrum and other network resources because the base station 110 may change which ROs are associated with which partitions without having to update any SIBs (or other broadcast messages). Additionally, the base station 110 can further reduce a size of the SIBs (or other messages) configuring the common pool and the partitions. Using smaller SIBs (or other messages) conserves processing resources, network resource, and power at the base station 110 and the UE 120. Using smaller SIBs (or other messages) additionally increases the chances that the UE 120 will receive and successfully decode the SIBs from the base station 110, which decreases latency before the UE 120 can communicate with the base station 110.

As indicated above, FIG. 8 is provided as an example. Other examples may differ from what is described with respect to FIG. 8.

FIG. 9 is a diagram illustrating an example 900 associated with requesting to use partitions of a common pool of resources for random access, in accordance with the present disclosure. As shown in FIG. 9, a base station 110 and a UE 120 may communicate with one another.

As shown in connection with reference number 905, the base station 110 may transmit, and the UE 120 may receive, a message indicating a common pool of resources for a RACH and an indication of a plurality of subsets (also referred to as “partitions”) within the common pool of resources. For example, the message and/or the indication may be included in one or more SIBs and/or other broadcast messages. Additionally, or alternatively, the message and/or the indication may be included in one or more RRC messages, one or more MAC-CEs, DCI, and/or other downlink messages. In some aspects, the message may indicate a starting frequency, a quantity of RACH occasions per slot, a time domain pattern indicator, and/or at least one preamble-transmission parameter (e.g., as described above in connection with FIG. 5).

In some aspects, the indication may include, for each subset, a corresponding mapping between an SSB and one or more corresponding ROs of the subset (e.g., as described above in connection with FIG. 6). Additionally, in some aspects, the indication may include, for at least one of the subsets, at least one preamble-transmission parameter (e.g., as described above in connection with FIG. 6).

The base station 110 may further indicate at least one use case associated with each subset. Accordingly, as shown in connection with reference number 910, when a random access is triggered at the UE 120, the UE 120 may determine which subset to use based at least in part on the use case that triggered the random access (e.g., as described above in connection with FIG. 6). In some aspects, the selected subset may include a portion of the common pool of resources that is not associated with a use case (e.g., when the use case that triggered the random access is not associated with a partition, as described above in connection with FIG. 6).

The base station 110 may further indicate that the subset associated with the use case that triggered the random access is on-demand. Accordingly, as shown in connection with reference number 915, the UE 120 may transmit, and the base station 110 may receive, an initial RACH preamble in order to activate the selected subset. In some aspects, the UE 120 may select the initial RACH preamble based at least in part on a mapping of one or more RACH preambles to one or more use cases (e.g., as described above in connection with FIG. 8). Accordingly, the base station 110 may determine which subset to activate based at least in part on the selected RACH preamble. Additionally, or alternatively, the UE 120 may transmit the initial RACH preamble with an RO that is selected based at least in part on a mapping of one or more ROs to one or more use cases (e.g., as described above in connection with FIG. 8). Accordingly, the base station 110 may determine which subset to activate based at least in part on the selected RO in which the UE 120 transmitted the initial RACH preamble. Additionally, or alternatively, the UE 120 may indicate which subset to activate in a payload associated with the initial RACH preamble (e.g., as described above in connection with FIG. 8). Accordingly, in some aspects, the UE 120 may transmit the initial RACH preamble in any RO associated with requests (e.g., within the common pool or within the request resources subset of the common pool, as described above in connection with FIG. 8).

As shown in connection with reference number 920, the base station 110 may transmit, and the UE 120 may receive, an indication that the subset, associated with the use case that triggered the random access, is activated. For example, the indication may be included in a MAC-CE, DCI, and/or another downlink message.

Accordingly, as shown in connection with reference number 925, the UE 120 may perform a RACH procedure using the activated subset. For example, the UE 120 may perform operations similar to those described above in connection with reference numbers 715 and 720 using the activated subset within the common pool.

In some aspects, the activation may have an associated expiry. For example, the activation may expire based at least in part on a maximum quantity of retransmissions (e.g., as indicated using a Preamble TransMax data element, as defined in 3GPP specifications and/or another standard) associated with the activated subset (or with the common pool when the base station 110 does not configure a maximum quantity of retransmissions for the subset). Accordingly, the activation may expire when the UE 120 transmits the maximum quantity of preambles within the subset. Additionally, or alternatively, the activation may expire based at least in part on a timer associated with the activated subset (or with the common pool when the base station 110 does not configure a timer for the subset). Accordingly, the activation may expire when the timer has run out. In a combinatory example, the activation may expire after an amount of time based at least in part on the maximum quantity of retransmissions and the timer (e.g., after N×T time has passed, where N may represent the maximum quantity of retransmissions, and T may represent the timer).

By using techniques as described in connection with FIG. 9, the base station 110 may more efficiently allocate PRACH resources between the partitions because the UE 120 will not use a particular partition until the partition is activated. As a result, the base station 110 does not have to reserve network resources for partitions that are not in use, which allows the base station 110 to more efficiently allocate spectrum and other network resources according to demand.

As indicated above, FIG. 9 is provided as an example. Other examples may differ from what is described with respect to FIG. 9.

FIG. 10 is a diagram illustrating an example 1000 associated with requesting to use partitions of a common pool of resources for random access, in accordance with the present disclosure. As shown in FIG. 10, a base station 110 and a UE 120 may communicate with one another.

As shown in connection with reference number 1005, the base station 110 may transmit, and the UE 120 may receive, a message indicating a common pool of resources for a RACH and an indication of a plurality of subsets (also referred to as “partitions”) within the common pool of resources. For example, the message and/or the indication may be included in one or more SIBs and/or other broadcast messages. Additionally, or alternatively, the message and/or the indication may be included in one or more RRC messages, one or more MAC-CEs, DCI, and/or other downlink messages. In some aspects, the message may indicate a starting frequency, a quantity of RACH occasions per slot, a time domain pattern indicator, and/or at least one preamble-transmission parameter (e.g., as described above in connection with FIG. 5).

The base station 110 may further indicate at least one use case associated with each subset. Accordingly, as shown in connection with reference number 1010, when a random access is triggered at the UE 120, the UE 120 may determine which subset to use based at least in part on the use case that triggered the random access (e.g., as described above in connection with FIG. 6). In some aspects, the selected subset may include a portion of the common pool of resources that is not associated with a use case (e.g., when the use case that triggered the random access is not associated with a partition, as described above in connection with FIG. 6).

The base station 110 may further indicate that the subset associated with the use case that triggered the random access is on-demand. Additionally, the base station 110 may not indicate which ROs, of the common pool, are included in the subset. Accordingly, as shown in connection with reference number 1015, the UE 120 may transmit, and the base station 110 may receive, an initial RACH preamble in order to receive information associated with the selected subset. For example, the information may include an indication of which ROs, of the common pool, are included in the subset. In some aspects, the UE 120 may select the initial RACH preamble based at least in part on a mapping of one or more RACH preambles to one or more use cases (e.g., as described above in connection with FIG. 8). Accordingly, the base station 110 may determine which subset the UE 120 is requesting information about, based at least in part on the selected RACH preamble. Additionally, or alternatively, the UE 120 may transmit the initial RACH preamble with an RO that is selected based at least in part on a mapping of one or more ROs to one or more use cases (e.g., as described above in connection with FIG. 8). Accordingly, the base station 110 may determine which subset the UE 120 is requesting information about, based at least in part on the selected RO in which the UE 120 transmitted the initial RACH preamble. Additionally, or alternatively, the UE 120 may indicate which subset the UE 120 is requesting information about, in a payload associated with the initial RACH preamble (e.g., as described above in connection with FIG. 8). Accordingly, in some aspects, the UE 120 may transmit the initial RACH preamble in any RO associated with requests (e.g., within the common pool or within the request resources subset of the common pool, as described above in connection with FIG. 8).

As shown in connection with reference number 1020, the base station 110 may transmit, and the UE 120 may receive, an indication of the subset associated with the use case that triggered the random access. For example, the indication may identify which ROs from the common pool are included in the subset. In some aspects, the indication may be included in a MAC-CE, DCI, and/or another downlink message. In some aspects, the indication may further serve as an activation of the subset (e.g., as described above in connection with FIG. 9).

Accordingly, as shown in connection with reference number 1025, the UE 120 may perform a RACH procedure using the activated subset. For example, the UE 120 may perform operations similar to those described above in connection with reference numbers 715 and 720 using the indicated subset within the common pool.

In some aspects, the indicated subset may have an associated expiry. For example, the subset may expire based at least in part on a maximum quantity of retransmissions (e.g., as indicated using a Preamble TransMax data element, as defined in 3GPP specifications and/or another standard) associated with the subset (or with the common pool when the base station 110 does not configure a maximum quantity of retransmissions for the subset). Accordingly, the indicated subset may expire when the UE 120 transmits the maximum quantity of preambles within the subset. Additionally, or alternatively, the indicated subset may expire based at least in part on a timer associated with the subset (or with the common pool when the base station 110 does not configure a timer for the subset). Accordingly, the indicated subset may expire when the timer has run out. In a combinatory example, the indicated subset may expire after an amount of time based at least in part on the maximum quantity of retransmissions and the timer (e.g., after N×T time has passed, where N may represent the maximum quantity of retransmissions, and T may represent the timer).

By using techniques as described in connection with FIG. 10, the base station 110 may more efficiently allocate PRACH resources between the partitions because the UE 120 will not use a particular partition until the partition is activated. As a result, the base station 110 does not have to reserve network resources for partitions that are not in use, which allows the base station 110 to more efficiently allocate spectrum and other network resources according to network demand. Additionally, the base station 110 does not indicate which ROs are associated with which partitions until the UE 120 transmits a request. As a result, the base station 110 can change which ROs are associated with which partitions, in response to network demand, without having to update any SIBs (or other broadcast messages). This conserves processing resources, network resources, and power at the base station 110.

By using techniques as described in connection with FIG. 10, the base station 110 also reduces a size of the SIBs (or other messages) configuring the common pool and the partitions. Using smaller SIBs (or other messages) conserves processing resources, network resource, and power at the base station 110 and the UE 120. Using smaller SIBs (or other messages) additionally increases the chances that the UE 120 will receive and successfully decode the SIBs from the base station 110, which decreases latency before the UE 120 can communicate with the base station 110.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120 and/or apparatus 1300 of FIG. 13) performs operations associated with using random access partitions for different use cases.

As shown in FIG. 11, in some aspects, process 1100 may include receiving, from a base station (e.g., base station 110 and/or apparatus 1400 of FIG. 14), a message indicating a common pool of resources for a RACH (block 1110). For example, the UE (e.g., using communication manager 140 and/or reception component 1302, depicted in FIG. 13) may receive a message indicating a common pool of resources for a RACH, as described herein.

As further shown in FIG. 11, in some aspects, process 1100 may include initiating a random access by transmitting, to the base station, a first RACH preamble in a RACH occasion within a subset of the common pool of resources (block 1120). For example, the UE (e.g., using communication manager 140 and/or transmission component 1304, depicted in FIG. 13) may initiate a random access by transmitting a first RACH preamble in a RACH occasion within a subset of the common pool of resources, as described herein. In some aspects, the subset is selected (e.g., using communication manager 140 and/or determination component 1308, depicted in FIG. 13) based at least in part on a use case that triggered the random access.

Process 1100 may include additional aspects, such as any single aspect or any combination of aspects described below and/or in connection with one or more other processes described elsewhere herein.

In a first aspect, the message includes a starting frequency, a quantity of RACH occasions per slot, a time domain pattern indicator, at least one preamble-transmission parameter, or a combination thereof.

In a second aspect, alone or in combination with the first aspect, process 1100 further includes receiving (e.g., using communication manager 140 and/or reception component 1302), from the base station, an indication of a plurality of subsets within the common pool of resources and at least one use case associated with each subset.

In a third aspect, alone or in combination with one or more of the first and second aspects, the indication includes, for each subset, a corresponding mapping between an SSB and one or more corresponding RACH occasions.

In a fourth aspect, alone or in combination with one or more of the first through third aspects, the indication includes, for at least one of the subsets, at least one preamble-transmission parameter.

In a fifth aspect, alone or in combination with one or more of the first through fourth aspects, the indication is included in an SIB from the base station.

In a sixth aspect, alone or in combination with one or more of the first through fifth aspects, the selected subset includes a portion of the common pool of resources that is not associated with a use case.

In a seventh aspect, alone or in combination with one or more of the first through sixth aspects, process 1100 further includes receiving (e.g., using communication manager 140 and/or reception component 1302), from the base station, an indication of a mapping of one or more RACH preambles to one or more use cases including the use case that triggered the random access; transmitting (e.g., using communication manager 140 and/or transmission component 1304), to the base station, an initial RACH preamble selected from the one or more RACH preambles based at least in part on the use case associated with the first RACH preamble; and receiving (e.g., using communication manager 140 and/or reception component 1302), from the base station, an indication that the subset of the common pool of resources, associated with the use case, is activated, such that the first RACH preamble is transmitted within the subset based at least in part on the indication that the subset is activated.

In an eighth aspect, alone or in combination with one or more of the first through seventh aspects, process 1100 further includes receiving (e.g., using communication manager 140 and/or reception component 1302), from the base station, an indication of a mapping of one or more RACH occasions to one or more use cases including the use case that triggered the random access; transmitting (e.g., using communication manager 140 and/or transmission component 1304), to the base station, an initial RACH preamble within an occasion of the one or more RACH occasions, based at least in part on the use case associated with the first RACH preamble; and receiving (e.g., using communication manager 140 and/or reception component 1302), from the base station, an indication that the subset of the common pool of resources, associated with the use case, is activated, such that the first RACH preamble is transmitted within the subset based at least in part on the indication that the subset is activated.

In a ninth aspect, alone or in combination with one or more of the first through eighth aspects, process 1100 further includes transmitting (e.g., using communication manager 140 and/or transmission component 1304), to the base station, an initial RACH preamble within the common pool of resources; transmitting (e.g., using communication manager 140 and/or transmission component 1304), to the base station, a RACH payload including an indication associated with the use case that triggered the random access; and receiving (e.g., using communication manager 140 and/or reception component 1302), from the base station, an indication that the subset of the common pool of resources, associated with the use case, is activated, such that the first RACH preamble is transmitted within the subset based at least in part on the indication that the subset is activated.

In a tenth aspect, alone or in combination with one or more of the first through ninth aspects, process 1100 further includes receiving (e.g., using communication manager 140 and/or reception component 1302), from the base station, an indication of a mapping of one or more RACH occasions to one or more use cases including the use case that triggered the random access; transmitting (e.g., using communication manager 140 and/or transmission component 1304), to the base station, an initial RACH preamble within an occasion of the one or more RACH occasions, based at least in part on the use case that triggered the random access; and receiving (e.g., using communication manager 140 and/or reception component 1302), from the base station, an indication of the subset of the common pool of resources associated with the use case, such that the first RACH preamble is transmitted within the subset based at least in part on the indication of the subset.

In an eleventh aspect, alone or in combination with one or more of the first through tenth aspects, process 1100 further includes receiving (e.g., using communication manager 140 and/or reception component 1302), from the base station, an indication of a mapping of one or more RACH preambles to one or more use cases including the use case that triggered the random access; transmitting (e.g., using communication manager 140 and/or transmission component 1304), to the base station, an initial RACH preamble selected from the one or more RACH preambles based at least in part on the use case that triggered the random access; and receiving (e.g., using communication manager 140 and/or reception component 1302), from the base station, an indication of the subset of the common pool of resources associated with the use case, such that the first RACH preamble is transmitted within the subset based at least in part on the indication of the subset.

In a twelfth aspect, alone or in combination with one or more of the first through eleventh aspects, process 1100 further includes transmitting (e.g., using communication manager 140 and/or transmission component 1304), to the base station, an initial RACH preamble within the common pool of resources; transmitting (e.g., using communication manager 140 and/or transmission component 1304), to the base station, a RACH payload including an indication associated with the use case that triggered the random access; and receiving (e.g., using communication manager 140 and/or reception component 1302), from the base station, an indication of the subset of the common pool of resources associated with the use case, such that the first RACH preamble is transmitted within the subset based at least in part on the indication of the subset.

In a thirteenth aspect, alone or in combination with one or more of the first through twelfth aspects, the subset of the common pool of resources is associated with an expiry, and the first RACH preamble is transmitted before the expiry.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110 and/or apparatus 1400 of FIG. 14) performs operations associated with configuring random access partitions for different use cases.

As shown in FIG. 12, in some aspects, process 1200 may include transmitting, to a UE (e.g., UE 120 and/or apparatus 1300 of FIG. 13), a message indicating a common pool of resources for a RACH (block 1210). For example, the base station (e.g., using communication manager 150 and/or transmission component 1404, depicted in FIG. 14) may transmit a message indicating a common pool of resources for a RACH, as described herein.

As further shown in FIG. 12, in some aspects, process 1200 may include receiving, from the UE, a first RACH preamble, to initiate a random access, in a RACH occasion within a subset of the common pool of resources (block 1220). For example, the base station (e.g., using communication manager 150 and/or reception component 1402, depicted in FIG. 14) may receive a first RACH preamble, to initiate a random access, in a RACH occasion within a subset of the common pool of resources, as described herein. In some aspects, the subset is selected based at least in part on a use case that triggered the random access.

Process 1200 may include additional aspects, such as any single aspect or any combination of aspects described below and/or in connection with one or more other processes described elsewhere herein.

In a first aspect, the message includes a starting frequency, a quantity of RACH occasions per slot, a time domain pattern indicator, at least one preamble-transmission parameter, or a combination thereof.

In a second aspect, alone or in combination with the first aspect, process 1200 further includes transmitting (e.g., using communication manager 150 and/or transmission component 1404), to the UE, an indication of a plurality of subsets within the common pool of resources and at least one use case associated with each subset.

In a third aspect, alone or in combination with one or more of the first and second aspects, the indication includes, for each subset, a corresponding mapping between an SSB and one or more corresponding RACH occasions.

In a fourth aspect, alone or in combination with one or more of the first through third aspects, the indication includes, for at least one of the subsets, at least one preamble-transmission parameter.

In a fifth aspect, alone or in combination with one or more of the first through fourth aspects, the indication is included in an SIB from the base station.

In a sixth aspect, alone or in combination with one or more of the first through fifth aspects, the selected subset includes a portion of the common pool of resources that is not associated with a use case.

In a seventh aspect, alone or in combination with one or more of the first through sixth aspects, process 1200 further includes transmitting (e.g., using communication manager 150 and/or transmission component 1404), to the UE, an indication of a mapping of one or more RACH preambles to one or more use cases including the use case that triggered the random access; receiving (e.g., using communication manager 150 and/or reception component 1402), from the UE, an initial RACH preamble selected from the one or more RACH preambles based at least in part on the use case that triggered the random access; and transmitting (e.g., using communication manager 150 and/or transmission component 1404), to the UE, an indication that the subset of the common pool of resources, associated with the use case, is activated, such that the first RACH preamble is received within the subset based at least in part on the indication that the subset is activated.

In an eighth aspect, alone or in combination with one or more of the first through seventh aspects, process 1200 further includes transmitting (e.g., using communication manager 150 and/or transmission component 1404), to the UE, an indication of a mapping of one or more RACH occasions to one or more use cases including the use case that triggered the random access; receiving (e.g., using communication manager 150 and/or reception component 1402), from the UE, an initial RACH preamble within an occasion of the one or more RACH occasions, based at least in part on the use case that triggered the random access; and transmitting (e.g., using communication manager 150 and/or transmission component 1404), to the UE, an indication that the subset of the common pool of resources, associated with the use case, is activated, such that the first RACH preamble is received within the subset based at least in part on the indication that the subset is activated.

In a ninth aspect, alone or in combination with one or more of the first through eighth aspects, process 1200 further includes receiving (e.g., using communication manager 150 and/or reception component 1402), from the UE, an initial RACH preamble within the common pool of resources; receiving (e.g., using communication manager 150 and/or reception component 1402), from the UE, a RACH payload including an indication associated with the use case that triggered the random access; and transmitting (e.g., using communication manager 150 and/or transmission component 1404), to the UE, an indication that the subset of the common pool of resources, associated with the use case, is activated, such that the first RACH preamble is received within the subset based at least in part on the indication that the subset is activated.

In a tenth aspect, alone or in combination with one or more of the first through ninth aspects, process 1200 further includes transmitting (e.g., using communication manager 150 and/or transmission component 1404), to the UE, an indication of a mapping of one or more RACH occasions to one or more use cases including the use case that triggered the random access; receiving (e.g., using communication manager 150 and/or reception component 1402), from the UE, an initial RACH preamble within an occasion of the one or more RACH occasions, based at least in part on the use case that triggered the random access; and transmitting (e.g., using communication manager 150 and/or transmission component 1404), to the UE, an indication of the subset of the common pool of resources associated with the use case, such that the first RACH preamble is received within the subset based at least in part on the indication of the subset.

In an eleventh aspect, alone or in combination with one or more of the first through tenth aspects, process 1200 further includes transmitting (e.g., using communication manager 150 and/or transmission component 1404), to the UE, an indication of a mapping of one or more RACH preambles to one or more use cases including the use case that triggered the random access; receiving (e.g., using communication manager 150 and/or reception component 1402), from the UE, an initial RACH preamble selected from the one or more RACH preambles based at least in part on the use case that triggered the random access; and transmitting (e.g., using communication manager 150 and/or transmission component 1404), to the UE, an indication of the subset of the common pool of resources associated with the use case, such that the first RACH preamble is received within the subset based at least in part on the indication of the subset.

In a twelfth aspect, alone or in combination with one or more of the first through eleventh aspects, process 1200 further includes receiving (e.g., using communication manager 150 and/or reception component 1402), from the UE, an initial RACH preamble within the common pool of resources; receiving (e.g., using communication manager 150 and/or reception component 1402), from the UE, a RACH payload including an indication associated with the use case that triggered the random access; and transmitting (e.g., using communication manager 150 and/or transmission component 1404), to the UE, an indication of the subset of the common pool of resources associated with the use case, such that the first RACH preamble is transmitted within the subset based at least in part on the indication of the subset.

In a thirteenth aspect, alone or in combination with one or more of the first through twelfth aspects, the subset of the common pool of resources is associated with an expiry, and the first RACH preamble is received before the expiry.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a block diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a determination component 1308, among other examples.

In some aspects, the apparatus 1300 may be configured to perform one or more operations described herein in connection with FIGS. 5-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the UE described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the UE described above in connection with FIG. 2. In some aspects, the transmission component 1304 may be co-located with the reception component 1302 in a transceiver.

In some aspects, the reception component 1302 may receive, from the apparatus 1306, a message indicating a common pool of resources for a RACH. Accordingly, the transmission component 1304 may initiate a random access by transmitting, to the apparatus 1306, a first RACH preamble in a RACH occasion within a subset of the common pool of resources. The subset may be selected based at least in part on a use case that triggered the random access. For example, the determination component 1308 may determine a use case that triggered the random access and select the subset based at least in part on determining the use case. In some aspects, the determination component 1308 may include a transmit MIMO processor, a transmit processor, a controller/processor, a memory, or a combination thereof, of the UE described above in connection with FIG. 2. In some aspects, the reception component 1302 may receive, from the apparatus 1306, an indication of a plurality of subsets within the common pool of resources and at least one use case associated with each subset. Accordingly, the determination component 1308 may select the subset based at least in part on the indication.

In some aspects, the reception component 1302 may receive, from the apparatus 1306, an indication of a mapping of one or more RACH preambles to one or more use cases including the use case that triggered the random access. Accordingly, the transmission component 1304 may transmit, to the apparatus 1306, an initial RACH preamble selected from the one or more RACH preambles based at least in part on the use case associated with the first RACH preamble. The reception component 1302 may receive, from the apparatus 1306, an indication that the subset of the common pool of resources, associated with the use case, is activated based at least in part on the transmission component 1304 transmitting the initial RACH preamble.

Additionally, or alternatively, the reception component 1302 may receive, from the apparatus 1306, an indication of a mapping of one or more RACH occasions to one or more use cases including the use case that triggered the random access.

Accordingly, the transmission component 1304 may transmit, to the apparatus 1306, an initial RACH preamble within an occasion of the one or more RACH occasions, based at least in part on the use case associated with the first RACH preamble. The reception component 1302 may receive, from the apparatus 1306, an indication that the subset of the common pool of resources, associated with the use case, is activated based at least in part on the transmission component 1304 transmitting the initial RACH preamble.

Additionally, or alternatively, the transmission component 1304 may transmit, to the apparatus 1306, an initial RACH preamble within the common pool of resources. The transmission component 1304 may further transmit, to the apparatus 1306, a RACH payload including an indication associated with the use case that triggered the random access. Accordingly, the reception component 1302 may receive, from the apparatus 1306, an indication that the subset of the common pool of resources, associated with the use case, is activated based at least in part on the transmission component 1304 transmitting the RACH payload.

Additionally, or alternatively, the reception component 1302 may receive, from the apparatus 1306, an indication of a mapping of one or more RACH occasions to one or more use cases including the use case that triggered the random access. Accordingly, the transmission component 1304 may transmit, to the apparatus 1306, an initial RACH preamble within an occasion of the one or more RACH occasions, based at least in part on the use case that triggered the random access. The reception component 1302 may receive, from the apparatus 1306, an indication of the subset of the common pool of resources associated with the use case based at least in part on the transmission component 1304 transmitting the initial RACH preamble.

Additionally, or alternatively, the reception component 1302 may receive, from the apparatus 1306, an indication of a mapping of one or more RACH preambles to one or more use cases including the use case that triggered the random access. Accordingly, the transmission component 1304 may transmit, to the apparatus 1306, an initial RACH preamble selected from the one or more RACH preambles based at least in part on the use case that triggered the random access. The reception component 1302 may receive, from the apparatus 1306, an indication of the subset of the common pool of resources associated with the use case based at least in part on the transmission component 1304 transmitting the initial RACH preamble.

Additionally, or alternatively, the transmission component 1304 may transmit, to the apparatus 1306, an initial RACH preamble within the common pool of resources. The transmission component 1304 may further transmit, to the apparatus 1306, a RACH payload including an indication associated with the use case that triggered the random access. Accordingly, the reception component 1302 may receive, from the apparatus 1306, an indication of the subset of the common pool of resources associated with the use case based at least in part on the transmission component 1304 transmitting the RACH payload.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a block diagram of an example apparatus 1400 for wireless communication. The apparatus 1400 may be a base station, or a base station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a partitioning component 1408, among other examples.

In some aspects, the apparatus 1400 may be configured to perform one or more operations described herein in connection with FIGS. 5-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the base station described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the base station described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the base station described above in connection with FIG. 2. In some aspects, the transmission component 1404 may be co-located with the reception component 1402 in a transceiver.

In some aspects, the transmission component 1404 may transmit, to the apparatus 1406, a message indicating a common pool of resources for a RACH. Accordingly, reception component 1402 may receive, from the apparatus 1406, a first RACH preamble, to initiate a random access, in a RACH occasion within a subset of the common pool of resources. The subset may be selected based at least in part on a use case that triggered the random access. In some aspects, the transmission component 1404 may transmit, to the apparatus 1406, an indication of a plurality of subsets within the common pool of resources and at least one use case associated with each subset. For example, the partitioning component 1408 may determine subsets within the common pool to associate with use cases such that the apparatus 1400 may infer use cases based at least in part on which subset is used by the UE 120. In some aspects, the partitioning component 1408 may include a MIMO detector, a receive processor, a controller/processor, a memory, or a combination thereof, of the base station described above in connection with FIG. 2.

In some aspects, the transmission component 1404 may transmit, to the apparatus 1406, an indication of a mapping of one or more RACH preambles to one or more use cases including the use case that triggered the random access. Accordingly, the reception component 1402 may receive, from the apparatus 1406, an initial RACH preamble selected from the one or more RACH preambles based at least in part on the use case that triggered the random access. The transmission component 1404 may transmit, to the apparatus 1406, an indication that the subset of the common pool of resources, associated with the use case, is activated based at least in part on the reception component 1402 receiving the initial RACH preamble.

Additionally, or alternatively, the transmission component 1404 may transmit, to the apparatus 1406, an indication of a mapping of one or more RACH occasions to one or more use cases including the use case that triggered the random access. Accordingly, the reception component 1402 may receive, from the apparatus 1406, an initial RACH preamble within an occasion of the one or more RACH occasions, based at least in part on the use case that triggered the random access. The transmission component 1404 may transmit, to the apparatus 1406, an indication that the subset of the common pool of resources, associated with the use case, is activated based at least in part on the reception component 1402 receiving the initial RACH preamble.

Additionally, or alternatively, the reception component 1402 may receive, from the apparatus 1406, an initial RACH preamble within the common pool of resources. The reception component 1402 may further receive, from the apparatus 1406, a RACH payload including an indication associated with the use case that triggered the random access. Accordingly, the transmission component 1404 may transmit, to the apparatus 1406, an indication that the subset of the common pool of resources, associated with the use case, is activated based at least in part on the reception component 1402 receiving the RACH payload.

Additionally, or alternatively, the transmission component 1404 may transmit, to the UE, an indication of a mapping of one or more RACH occasions to one or more use cases including the use case that triggered the random access. Accordingly, the reception component 1402 may receive, from the apparatus 1406, an initial RACH preamble within an occasion of the one or more RACH occasions, based at least in part on the use case that triggered the random access. The transmission component 1404 may transmit, to the apparatus 1406, an indication of the subset of the common pool of resources associated with the use case based at least in part on the reception component 1402 receiving the initial RACH preamble.

Additionally, or alternatively, the transmission component 1404 may transmit, to the apparatus 1406, an indication of a mapping of one or more RACH preambles to one or more use cases including the use case that triggered the random access. Accordingly, the reception component 1402 may receive, from the apparatus 1406, an initial RACH preamble selected from the one or more RACH preambles based at least in part on the use case that triggered the random access. The transmission component 1404 may transmit, to the apparatus 1406, an indication of the subset of the common pool of resources associated with the use case based at least in part on the reception component 1402 receiving the initial RACH preamble.

Additionally, or alternatively, the reception component 1402 may receive, from the apparatus 1406, an initial RACH preamble within the common pool of resources. The reception component 1402 may further receive, from the apparatus 1406, a RACH payload including an indication associated with the use case that triggered the random access. Accordingly, the transmission component 1404 may transmit, to the apparatus 1406, an indication of the subset of the common pool of resources associated with the use case based at least in part on the reception component 1402 receiving the RACH payload.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a base station, a message indicating a common pool of resources for a random access channel (RACH); and initiating a random access by transmitting, to the base station, a first RACH preamble in a RACH occasion within a subset of the common pool of resources, wherein the subset is selected based at least in part on a use case that triggered the random access.

Aspect 2: The method of Aspect 1, wherein the message includes a starting frequency, a quantity of RACH occasions per slot, a time domain pattern indicator, at least one preamble-transmission parameter, or a combination thereof.

Aspect 3: The method of any of Aspects 1 through 2, further comprising: receiving, from the base station, an indication of a plurality of subsets within the common pool of resources and at least one use case associated with each subset.

Aspect 4: The method of Aspect 3, wherein the indication includes, for each subset, a corresponding mapping between a synchronization signal block (SSB) and one or more corresponding RACH occasions.

Aspect 5: The method of any of Aspects 3 through 4, wherein the indication includes, for at least one of the subsets, at least one preamble-transmission parameter.

Aspect 6: The method of any of Aspects 3 through 5, wherein the indication is included in a system information block (SIB) from the base station.

Aspect 7: The method of any of Aspects 1 through 6, wherein the selected subset includes a portion of the common pool of resources that is not associated with a use case.

Aspect 8: The method of any of Aspects 1 through 7, further comprising: receiving, from the base station, an indication of a mapping of one or more RACH preambles to one or more use cases including the use case that triggered the random access; transmitting, to the base station, an initial RACH preamble selected from the one or more RACH preambles based at least in part on the use case associated with the first RACH preamble; and receiving, from the base station, an indication that the subset of the common pool of resources, associated with the use case, is activated, wherein the first RACH preamble is transmitted within the subset based at least in part on the indication that the subset is activated.

Aspect 9: The method of any of Aspects 1 through 7, further comprising: receiving, from the base station, an indication of a mapping of one or more RACH occasions to one or more use cases including the use case that triggered the random access; transmitting, to the base station, an initial RACH preamble within an occasion of the one or more RACH occasions, based at least in part on the use case associated with the first RACH preamble; and receiving, from the base station, an indication that the subset of the common pool of resources, associated with the use case, is activated, wherein the first RACH preamble is transmitted within the subset based at least in part on the indication that the subset is activated.

Aspect 10: The method of any of Aspects 1 through 7, further comprising: transmitting, to the base station, an initial RACH preamble within the common pool of resources; transmitting, to the base station, a RACH payload including an indication associated with the use case that triggered the random access; and receiving, from the base station, an indication that the subset of the common pool of resources, associated with the use case, is activated, wherein the first RACH preamble is transmitted within the subset based at least in part on the indication that the subset is activated.

Aspect 11: The method of any of Aspects 1 through 7, further comprising: receiving, from the base station, an indication of a mapping of one or more RACH occasions to one or more use cases including the use case that triggered the random access; transmitting, to the base station, an initial RACH preamble within an occasion of the one or more RACH occasions, based at least in part on the use case that triggered the random access; and receiving, from the base station, an indication of the subset of the common pool of resources associated with the use case, wherein the first RACH preamble is transmitted within the subset based at least in part on the indication of the subset.

Aspect 12: The method of any of Aspects 1 through 7, further comprising: receiving, from the base station, an indication of a mapping of one or more RACH preambles to one or more use cases including the use case that triggered the random access; transmitting, to the base station, an initial RACH preamble selected from the one or more RACH preambles based at least in part on the use case that triggered the random access; and receiving, from the base station, an indication of the subset of the common pool of resources associated with the use case, wherein the first RACH preamble is transmitted within the subset based at least in part on the indication of the subset.

Aspect 13: The method of any of Aspects 1 through 7, further comprising: transmitting, to the base station, an initial RACH preamble within the common pool of resources; transmitting, to the base station, a RACH payload including an indication associated with the use case that triggered the random access; and receiving, from the base station, an indication of the subset of the common pool of resources associated with the use case, wherein the first RACH preamble is transmitted within the subset based at least in part on the indication of the subset.

Aspect 14: The method of any of Aspects 1 through 13, wherein the subset of the common pool of resources is associated with an expiry, and the first RACH preamble is transmitted before the expiry.

Aspect 15: A method of wireless communication performed by a base station, comprising: transmitting, to a user equipment (UE), a message indicating a common pool of resources for a random access channel (RACH); and receiving, from the UE, a first RACH preamble, to initiate a random access, in a RACH occasion within a subset of the common pool of resources, wherein the subset is selected based at least in part on a use case that triggered the random access.

Aspect 16: The method of Aspect 15, wherein the message includes a starting frequency, a quantity of RACH occasions per slot, a time domain pattern indicator, at least one preamble-transmission parameter, or a combination thereof.

Aspect 17: The method of any of Aspects 15 through 16, further comprising: transmitting, to the UE, an indication of a plurality of subsets within the common pool of resources and at least one use case associated with each subset.

Aspect 18: The method of Aspect 17, wherein the indication includes, for each subset, a corresponding mapping between a synchronization signal block (SSB) and one or more corresponding RACH occasions.

Aspect 19: The method of any of Aspects 17 through 18, wherein the indication includes, for at least one of the subsets, at least one preamble-transmission parameter.

Aspect 20: The method of any of Aspects 17 through 19, wherein the indication is included in a system information block (SIB) from the base station.

Aspect 21: The method of any of Aspects 15 through 20, wherein the selected subset includes a portion of the common pool of resources that is not associated with a use case.

Aspect 22: The method of any of Aspects 15 through 21, further comprising: transmitting, to the UE, an indication of a mapping of one or more RACH preambles to one or more use cases including the use case that triggered the random access; receiving, from the UE, an initial RACH preamble selected from the one or more RACH preambles based at least in part on the use case that triggered the random access; and transmitting, to the UE, an indication that the subset of the common pool of resources, associated with the use case, is activated, wherein the first RACH preamble is received within the subset based at least in part on the indication that the subset is activated.

Aspect 23: The method of any of Aspects 15 through 21, further comprising: transmitting, to the UE, an indication of a mapping of one or more RACH occasions to one or more use cases including the use case that triggered the random access; receiving, from the UE, an initial RACH preamble within an occasion of the one or more RACH occasions, based at least in part on the use case that triggered the random access; and transmitting, to the UE, an indication that the subset of the common pool of resources, associated with the use case, is activated, wherein the first RACH preamble is received within the subset based at least in part on the indication that the subset is activated.

Aspect 24: The method of any of Aspects 15 through 21, further comprising: receiving, from the UE, an initial RACH preamble within the common pool of resources; receiving, from the UE, a RACH payload including an indication associated with the use case that triggered the random access; and transmitting, to the UE, an indication that the subset of the common pool of resources, associated with the use case, is activated, wherein the first RACH preamble is received within the subset based at least in part on the indication that the subset is activated.

Aspect 25: The method of any of Aspects 15 through 21, further comprising: transmitting, to the UE, an indication of a mapping of one or more RACH occasions to one or more use cases including the use case that triggered the random access; receiving, from the UE, an initial RACH preamble within an occasion of the one or more RACH occasions, based at least in part on the use case that triggered the random access; and transmitting, to the UE, an indication of the subset of the common pool of resources associated with the use case, wherein the first RACH preamble is received within the subset based at least in part on the indication of the subset.

Aspect 26: The method of any of Aspects 15 through 21, further comprising: transmitting, to the UE, an indication of a mapping of one or more RACH preambles to one or more use cases including the use case that triggered the random access; receiving, from the UE, an initial RACH preamble selected from the one or more RACH preambles based at least in part on the use case that triggered the random access; and transmitting, to the UE, an indication of the subset of the common pool of resources associated with the use case, wherein the first RACH preamble is received within the subset based at least in part on the indication of the subset.

Aspect 27: The method of any of Aspects 15 through 21, further comprising: receiving, from the UE, an initial RACH preamble within the common pool of resources; receiving, from the UE, a RACH payload including an indication associated with the use case that triggered the random access; and transmitting, to the UE, an indication of the subset of the common pool of resources associated with the use case, wherein the first RACH preamble is transmitted within the subset based at least in part on the indication of the subset.

Aspect 28: The method of any of Aspects 15 through 27, wherein the subset of the common pool of resources is associated with an expiry, and the first RACH preamble is received before the expiry.

Aspect 29: An apparatus for wireless communication at a device, comprising a processor; memory coupled with the processor; and instructions stored in the memory and executable by the processor to cause the apparatus to perform the method of one or more Aspects of Aspects 1-14.

Aspect 30: A device for wireless communication, comprising a memory and one or more processors coupled to the memory, the memory and the one or more processors configured to perform the method of one or more Aspects of Aspects 1-14.

Aspect 31: An apparatus for wireless communication, comprising at least one means for performing the method of one or more Aspects of Aspects 1-14.

Aspect 32: A non-transitory computer-readable medium storing code for wireless communication, the code comprising instructions executable by a processor to perform the method of one or more Aspects of Aspects 1-14.

Aspect 33: A non-transitory computer-readable medium storing a set of instructions for wireless communication, the set of instructions comprising one or more instructions that, when executed by one or more processors of a device, cause the device to perform the method of one or more Aspects of Aspects 1-14.

Aspect 34: An apparatus for wireless communication at a device, comprising a processor; memory coupled with the processor; and instructions stored in the memory and executable by the processor to cause the apparatus to perform the method of one or more Aspects of Aspects 15-28.

Aspect 35: A device for wireless communication, comprising a memory and one or more processors coupled to the memory, the memory and the one or more processors configured to perform the method of one or more Aspects of Aspects 15-28

Aspect 36: An apparatus for wireless communication, comprising at least one means for performing the method of one or more Aspects of Aspects 15-28.

Aspect 37: A non-transitory computer-readable medium storing code for wireless communication, the code comprising instructions executable by a processor to perform the method of one or more Aspects of Aspects 15-28.

Aspect 38: A non-transitory computer-readable medium storing a set of instructions for wireless communication, the set of instructions comprising one or more instructions that, when executed by one or more processors of a device, cause the device to perform the method of one or more Aspects of Aspects 15-28.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE):
one or more memories; and
one or more processors coupled to the memory, the one or more processors configured to:
receive a message indicating a common pool of resources for a random access channel (RACH); and
initiate a random access by transmitting a first RACH preamble in a RACH occasion within a subset of the common pool of resources, wherein the subset is selected based at least in part on a use case that triggered the random access.

2. The apparatus of claim 1, wherein the message includes a starting frequency, a quantity of RACH occasions per slot, a time domain pattern indicator, at least one preamble-transmission parameter, or a combination thereof.

3. The apparatus of claim 1, wherein the one or more processors are further configured to:
receive an indication of a plurality of subsets within the common pool of resources and at least one use case associated with each subset.

4. The apparatus of claim 3, wherein the indication includes, for each subset, a corresponding mapping between a synchronization signal block (SSB) and one or more corresponding RACH occasions.

5. The apparatus of claim 3, wherein the indication includes, for at least one of the subsets, at least one preamble-transmission parameter.

6. (canceled)

7. The apparatus of claim 1, wherein the selected subset includes a portion of the common pool of resources that is not associated with a use case.

8. The apparatus of claim 1, wherein the one or more processors are further configured to:
receive an indication of a mapping of one or more RACH preambles to one or more use cases including the use case that triggered the random access;
transmit an initial RACH preamble selected from the one or more RACH preambles based at least in part on the use case associated with the first RACH preamble; and
receive an indication that the subset of the common pool of resources, associated with the use case, is activated,
wherein the first RACH preamble is transmitted within the subset based at least in part on the indication that the subset is activated.

9. The apparatus of claim 1, wherein the one or more processors are further configured to:
receive an indication of a mapping of one or more RACH occasions to one or more use cases including the use case that triggered the random access;
transmit an initial RACH preamble within an occasion of the one or more RACH occasions, based at least in part on the use case associated with the first RACH preamble; and
receive an indication that the subset of the common pool of resources, associated with the use case, is activated,
wherein the first RACH preamble is transmitted within the subset based at least in part on the indication that the subset is activated.

10. The apparatus of claim 1, wherein the one or more processors are further configured to:
transmit an initial RACH preamble within the common pool of resources;
transmit a RACH payload including an indication associated with the use case that triggered the random access; and
receive an indication that the subset of the common pool of resources, associated with the use case, is activated,
wherein the first RACH preamble is transmitted within the subset based at least in part on the indication that the subset is activated.

11. The apparatus of claim 1, wherein the one or more processors are further configured to:
receive an indication of a mapping of one or more RACH occasions to one or more use cases including the use case that triggered the random access;
transmit an initial RACH preamble within an occasion of the one or more RACH occasions, based at least in part on the use case that triggered the random access; and
receive an indication of the subset of the common pool of resources associated with the use case,
wherein the first RACH preamble is transmitted within the subset based at least in part on the indication of the subset.

12. The apparatus of claim 1, wherein the one or more processors are further configured to:
receive an indication of a mapping of one or more RACH preambles to one or more use cases including the use case that triggered the random access;
transmit an initial RACH preamble selected from the one or more RACH preambles based at least in part on the use case that triggered the random access; and
receive an indication of the subset of the common pool of resources associated with the use case,
wherein the first RACH preamble is transmitted within the subset based at least in part on the indication of the subset.

13. The apparatus of claim 1, wherein the one or more processors are further configured to:
transmit an initial RACH preamble within the common pool of resources;
transmit a RACH payload including an indication associated with the use case that triggered the random access; and
receive an indication of the subset of the common pool of resources associated with the use case,
wherein the first RACH preamble is transmitted within the subset based at least in part on the indication of the subset.

14. (canceled)

15. An apparatus for wireless communication at a network node, comprising:
one or more memories; and
one or more processors coupled to the memory, the one or more processors configured to:
transmit a message indicating a common pool of resources for a random access channel (RACH); and
receive a first RACH preamble, to initiate a random access, in a RACH occasion within a subset of the common pool of resources, wherein the subset is selected based at least in part on a use case that triggered the random access.

16. The apparatus of claim 15, wherein the message includes a starting frequency, a quantity of RACH occasions per slot, a time domain pattern indicator, at least one preamble-transmission parameter, or a combination thereof.

17. The apparatus of claim 15, wherein the one or more processors are further configured to:
transmit an indication of a plurality of subsets within the common pool of resources and at least one use case associated with each subset.

18. The apparatus of claim 17, wherein the indication includes, for each subset, a corresponding mapping between a synchronization signal block (SSB) and one or more corresponding RACH occasions.

19. The apparatus of claim 17, wherein the indication includes, for at least one of the subsets, at least one preamble-transmission parameter.

20. (canceled)

21. The apparatus of claim 15, wherein the selected subset includes a portion of the common pool of resources that is not associated with a use case.

22. The apparatus of claim 15, wherein the one or more processors are further configured to:
transmit an indication of a mapping of one or more RACH preambles to one or more use cases including the use case that triggered the random access;
receive an initial RACH preamble selected from the one or more RACH preambles based at least in part on the use case associated with the first RACH preamble; and
transmit an indication that the subset of the common pool of resources, associated with the use case, is activated,
wherein the first RACH preamble is received within the subset based at least in part on the indication that the subset is activated.

23. The apparatus of claim 15, wherein the one or more processors are further configured to:
transmit an indication of a mapping of one or more RACH occasions to one or more use cases including the use case that triggered the random access;
receive an initial RACH preamble within an occasion of the one or more RACH occasions, based at least in part on the use case associated with the first RACH preamble; and
transmit an indication that the subset of the common pool of resources, associated with the use case, is activated,
wherein the first RACH preamble is received within the subset based at least in part on the indication that the subset is activated.

24. The apparatus of claim 15, wherein the one or more processors are further configured to:
receive an initial RACH preamble within the common pool of resources;
receive a RACH payload including an indication associated with the use case that triggered the random access; and
transmit an indication that the subset of the common pool of resources, associated with the use case, is activated,
wherein the first RACH preamble is received within the subset based at least in part on the indication that the subset is activated.

25. The apparatus of claim 15, wherein the one or more processors are further configured to:
transmit an indication of a mapping of one or more RACH occasions to one or more use cases including the use case that triggered the random access;
receive an initial RACH preamble within an occasion of the one or more RACH occasions, based at least in part on the use case that triggered the random access; and
transmit an indication of the subset of the common pool of resources associated with the use case,
wherein the first RACH preamble is received within the subset based at least in part on the indication of the subset.

26. The apparatus of claim 15, wherein the one or more processors are further configured to:
transmit an indication of a mapping of one or more RACH preambles to one or more use cases including the use case that triggered the random access;
receive an initial RACH preamble selected from the one or more RACH preambles based at least in part on the use case that triggered the random access; and
transmit an indication of the subset of the common pool of resources associated with the use case,
wherein the first RACH preamble is received within the subset based at least in part on the indication of the subset.

27. The apparatus of claim 15, wherein the one or more processors are further configured to:
receive an initial RACH preamble within the common pool of resources;
receive a RACH payload including an indication associated with the use case that triggered the random access; and
transmit an indication of the subset of the common pool of resources associated with the use case,
wherein the first RACH preamble is received within the subset based at least in part on the indication of the subset.

28. (canceled)

29. A method of wireless communication for a user equipment (UE), comprising:
receiving a message indicating a common pool of resources for a random access channel (RACH); and
initiating a random access by transmitting a first RACH preamble in a RACH occasion within a subset of the common pool of resources, wherein the subset is selected based at least in part on a use case that triggered the random access.

30. (canceled)

31. The method of claim 29, further comprising:
receiving an indication of a plurality of subsets within the common pool of resources and at least one use case associated with each subset.

32. (canceled)

33. The method of claim 31, wherein the indication includes, for at least one of the subsets, at least one preamble-transmission parameter.

34-42. (canceled)

43. A method of wireless communication for a network node, comprising:
transmitting a message indicating a common pool of resources for a random access channel (RACH); and
receiving a first RACH preamble, to initiate a random access, in a RACH occasion within a subset of the common pool of resources, wherein the subset is selected based at least in part on a use case that triggered the random access.

44. (canceled)

45. The method of claim 43, further comprising:
transmitting an indication of a plurality of subsets within the common pool of resources and at least one use case associated with each subset.

46. (canceled)

47. The method of claim 45, wherein the indication includes, for at least one of the subsets, at least one preamble-transmission parameter.

48-60. (canceled)
